(19) United States
(12) Patent Application Publication
(10) Pub. No.: US 2017/0006346 A1
(43) Pub. Date: Jan. 5, 2017

(54) VIDEO RECEIVING APPARATUS AND VIDEO DISPLAY METHOD

(71) Applicant: Panasonic Intellectual Property Management Co., Ltd., Osaka (JP)

(72) Inventor: Kasai ONO, Tokyo (JP)

(21) Appl. No.: 15/186,907

(22) Filed: Jun. 20, 2016

(30) Foreign Application Priority Data
Jun. 30, 2015 (JP) 2015-131884
Dec. 25, 2015 (JP) 2015-255269

(51) Int. Cl. H04N 21/482; H04N 21/422; H04N 5/50; H04N 21/472; H04N 5/44; H04N 5/445

(52) U.S. Cl. CPC H04N 21/4821; H04N 5/4403; H04N 5/44543; H04N 5/50; H04N 21/47202; H04N 21/42222; H04N 2005/441; H04N 2005/44556

(57) ABSTRACT

A video receiving apparatus includes a video processor, and is configured to activate content browser in response to an operation of a viewer and cause a video display apparatus to display a browser video generated by the content browser assisting the viewer in selecting a desired service from a plurality of the services that may be viewed at identical time. The video processor displays moving picture content in a first aspect until displaying the browser video. When a predetermined condition is satisfied, the video processor displays the moving picture content along with the browser video in a second aspect different from the first aspect.

### BACKGROUND

1. Technical Field

The present disclosure relates to a video receiving apparatus and a video display method for enabling display of a content browser screen that is a channel selection service for allowing selection of one service from a plurality of services.

2. Description of the Related Art

Unexamined Japanese Patent Publication No. 2009-130901 describes a technique for displaying advertising content by utilizing a period of time until a broadcast service is displayed after turning on power of a television receiver capable of receiving digital broadcasting, or after a change in a selected channel.

### SUMMARY

The present disclosure provides a video receiving apparatus and video display method which can present a viewer with information without wasting time until the content browser is activated.

The video receiving apparatus according to the present disclosure includes the content browser that assists a viewer in selecting a desired service from a plurality of services, and the video processor. The content browser is activated by an operation of the viewer. The content browser generates a browser video and then displays the generated browser video on a video display apparatus. The video processor displays moving picture content in a first aspect until displaying the browser video. When a predetermined condition is satisfied, the video processor displays the moving picture content along with the browser video in a second aspect different from the first aspect.

The video receiving apparatus and video display method according to the present disclosure can present a viewer with information without wasting time until the content browser is activated.

### BRIEF DESCRIPTION OF THE DRAWINGS

FIG. 1 is a diagram illustrating a relationship among a video receiving apparatus, broadcasting station, portal server, and TV according to an exemplary embodiment;

FIG. 2A is a block diagram illustrating an example of a configuration of the video receiving apparatus according to the exemplary embodiment;

FIG. 2B is a diagram illustrating an example of specification information according to the exemplary embodiment;

FIG. 3 is a block diagram illustrating an example of a configuration of the broadcasting station according to the exemplary embodiment;

FIG. 4A is a block diagram illustrating an example of a configuration of the portal server according to the exemplary embodiment;

FIG. 4B is a diagram illustrating an example of mapping information according to the exemplary embodiment;

FIG. 4C is a block diagram illustrating an example of a configuration of a moving picture distributing server according to the exemplary embodiment;

FIG. 5A is a diagram illustrating an example of the TV that displays a video that is output from an STB in a normal mode according to the exemplary embodiment;

FIG. 5B is a diagram illustrating an example of the TV that displays moving picture content in a first aspect according to the exemplary embodiment;

FIG. 5C is a diagram illustrating an example of the TV that displays a browser video along with the moving picture content in a second aspect according to the exemplary embodiment;

FIG. 5D is a diagram illustrating an example of the TV that displays a cursor pointing at the moving picture content in the second aspect according to the exemplary embodiment;

FIG. 5E is a diagram illustrating an example of the TV that displays the cursor after display of the moving picture content is finished according to the exemplary embodiment;

FIG. 6A is a flowchart illustrating a procedure for displaying the moving picture content in the first aspect according to the exemplary embodiment;

FIG. 6B is a flowchart illustrating a procedure for displaying the browser video according to the exemplary embodiment;

FIG. 6C is a flowchart illustrating a procedure for displaying and moving the cursor according to the exemplary embodiment;

FIG. 7 is a diagram illustrating an example of a template video according to the exemplary embodiment;

FIG. 8A is a diagram illustrating an example of a reduced video group according to the exemplary embodiment;

FIG. 8B is a diagram illustrating a relationship between a plurality of reduced videos included in the reduced video group and application regions thereof according to the exemplary embodiment;

FIG. 9 is a flowchart illustrating an example of a processing procedure of a method for acquiring the browser video and audio according to the exemplary embodiment;

FIG. 10A is a diagram illustrating an example of a first browser video according to the exemplary embodiment;

FIG. 10B is a diagram illustrating another example of the first browser video according to the exemplary embodiment;

FIG. 10C is a diagram illustrating an example of a second browser video according to the exemplary embodiment;

FIG. 10D is a diagram illustrating another example of the second browser video according to the exemplary embodiment;

FIG. 11 is a diagram illustrating an example of the browser video on page 1 according to variation 1;

FIG. 12A is a diagram illustrating an example of the browser video on and after page 2 according to variation 1;

FIG. 12B is a diagram illustrating another example of the browser video on and after page 2 according to variation 1;

FIG. 13 is a diagram illustrating an example of the first browser video after a specification change according to variation 2;

FIG. 14 is a diagram illustrating an example of specification information after the specification change according to variation 2; and

FIG. 15 is a diagram illustrating an example of the reduced video group in another exemplary embodiment.

### DETAILED DESCRIPTION

When there are a lot of services a viewer may view, a method for describing information on respective services by using text like a conventional electronic program guide (EPG) has a problem that the viewer may not know details of the services intuitively and easily.

Meanwhile, a method may be used for displaying reduced videos of the plurality of services (hereinafter referred to as “reduced videos” as needed) on one screen. Moving pictures allow a viewer to know information on the large number of services intuitively and all at once.

However, when the reduced videos of the plurality of services are simultaneously displayed on one screen, it is necessary to obtain permission for simultaneous display of each video with other videos from a right holder of each video. This is because legal problems can be caused by a display of the reduced video of a service having no permission together with the reduced videos of other services simultaneously on one screen. This makes it difficult to present reduced videos of a lot of services to a viewer by using a content browser, if the services a viewer may view include a service having no permission for a simultaneous display with other videos.

Therefore, a separate patent application has been filed for a video receiving apparatus capable of providing a channel selection service according to the aforementioned permission, even if there is a mixture of a service that has no permission for a simultaneous display with reduced videos of other services on one screen, and a service that has such permission. This may present more reduced videos to a viewer while avoiding legal problems.

However, for example, the content browser for implementing the above-described complicated channel selection service is likely to need an increasing amount of information processing. Accordingly, it takes time to display the reduced videos after the viewer performs an operation to activate the content browser, which causes waiting time for the viewer.

The video receiving apparatus and the video display method according to the present disclosure can provide a channel selection service that utilizes such waiting time.

An exemplary embodiment will be described in detail below with reference to the drawings as needed. However, a description more detailed than necessary may be omitted. For example, a detailed description of already well-known matters and a repeated description regarding substantially identical components may be omitted. This is intended to avoid making the following description unnecessarily redundant and to make it easier for a person skilled in the art to understand the exemplary embodiment.

It is to be noted that the inventor provides the accompanying drawings and the following description in order for a person skilled in the art to fully understand the present disclosure, and that the inventor does not intend to limit the subject described in the appended claims.

### EXEMPLARY EMBODIMENT

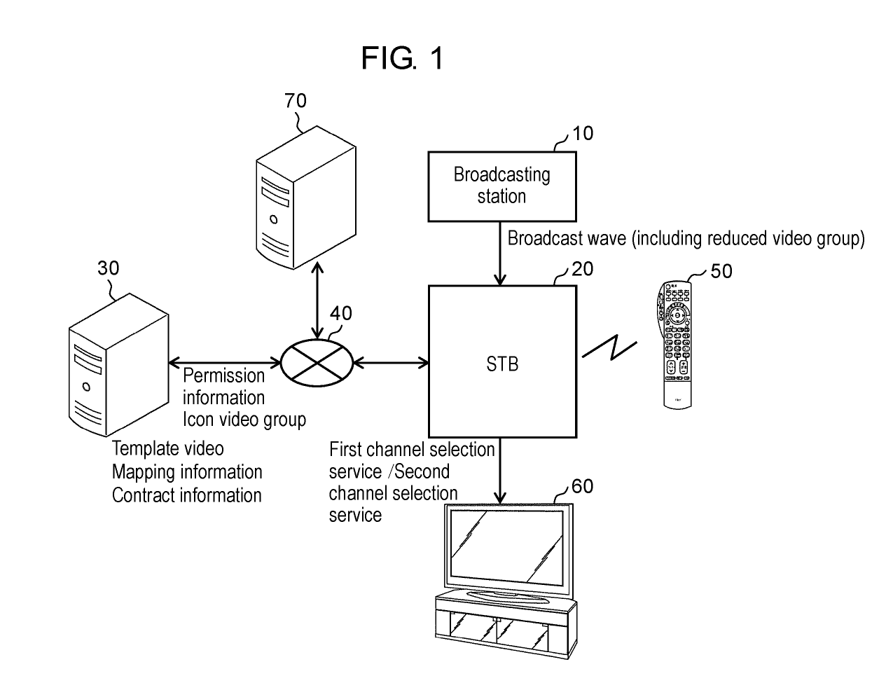

A video receiving apparatus and a video display method according to the exemplary embodiment will be described below with reference to FIG. 1 to FIG. 10D.

The video receiving apparatus according to the present exemplary embodiment causes a video display apparatus to display a browser video that indicates services a viewer may view at identical time. A content browser is activated by an operation of the viewer who is viewing the services, and then the content browser assists the viewer in selecting each of the services to view based on a list of icon videos that indicates the services that may be viewed at identical time. In the present exemplary embodiment, the content browser provides a channel selection service for allowing the viewer to select one service from among the plurality of services including a plurality of first services and a plurality of second services. That is, the content browser provides the channel selection service that may be used even if there is a mixture of the service that has permission for a simultaneous display with other videos, and the service that has no such permission.

Note that in the following description, each of the first services is a service that has no permission for a simultaneous display of the reduced videos with the reduced videos of other services on one screen, and each of the second services is a service that has such permission. However, a type of service is not particularly limited. In addition, although the following describes the content browser that simultaneously displays the reduced videos of the first service and moving picture content in a second aspect, the content browser is not limited to this example. For example, when a right holder of the first service does not permit a simultaneous display of the video of the first service with the moving picture content, it is also possible to avoid displaying the reduced videos of the first service and the moving picture content simultaneously. That is, it is possible to avoid displaying the reduced videos of the first service when the moving picture content is displayed. In addition, it is possible to avoid displaying the moving picture content when the reduced videos of the first service are displayed. In addition, in the following description, the second service is a service that has permission for a simultaneous display of the reduced videos with the moving picture content. The moving picture content may be a video that has a relationship with neither the first service nor the second service, and the moving picture content is typically an advertising moving picture (advertising content).

The content browser of the video receiving apparatus according to the present exemplary embodiment provides one of a first browser video and a second browser video, according to whether the service indicated by a cursor is the first service or the second service.

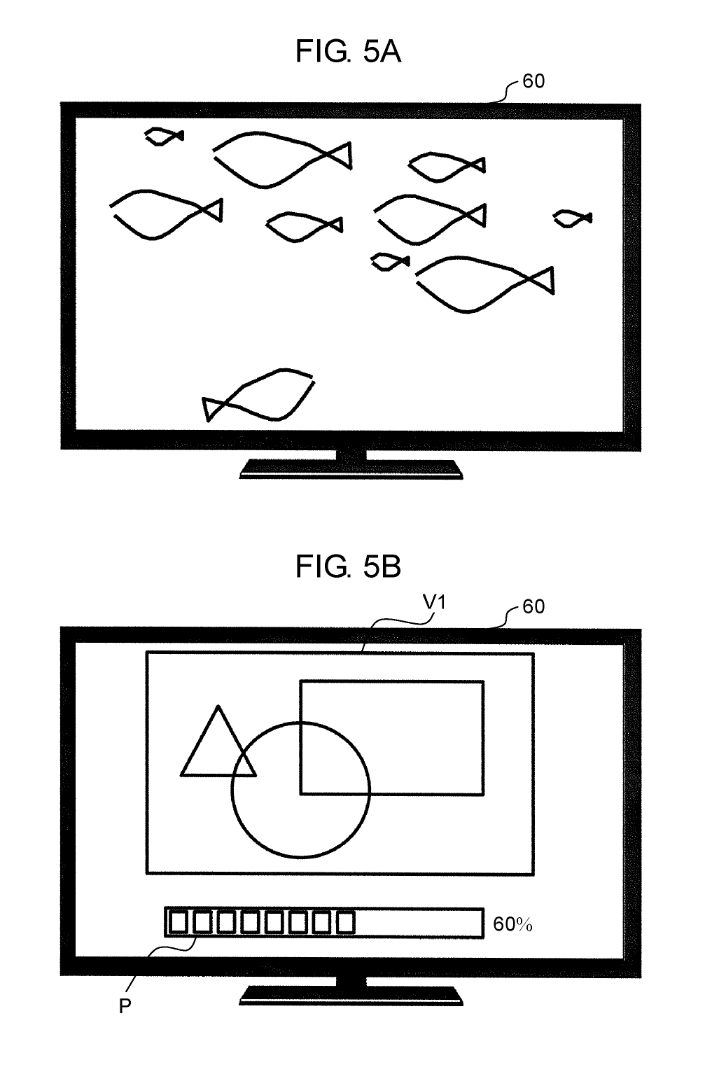

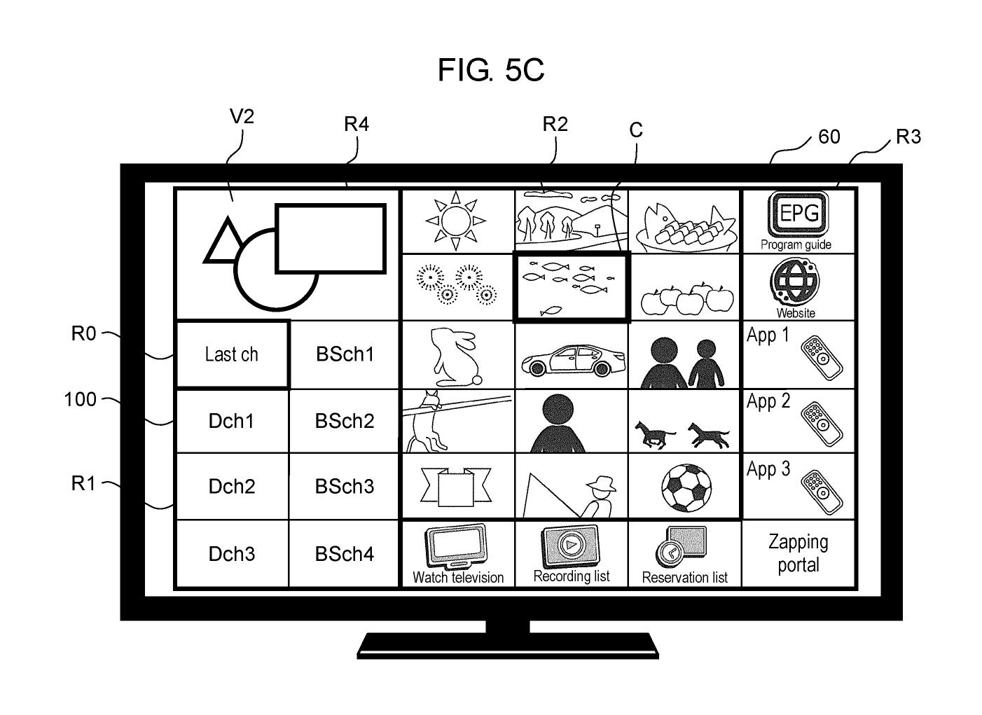

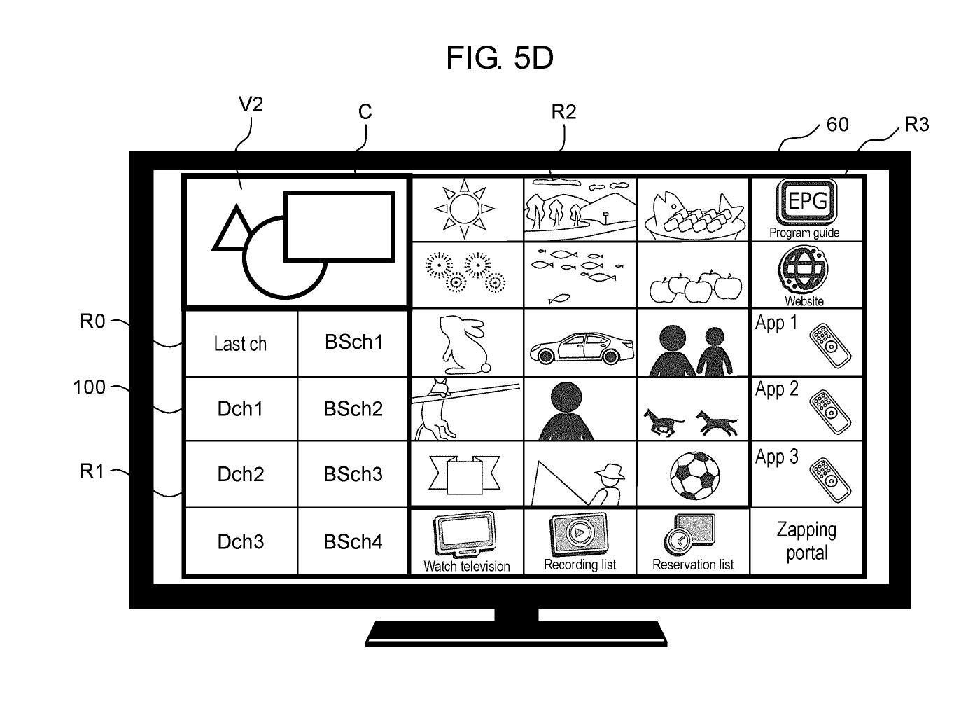

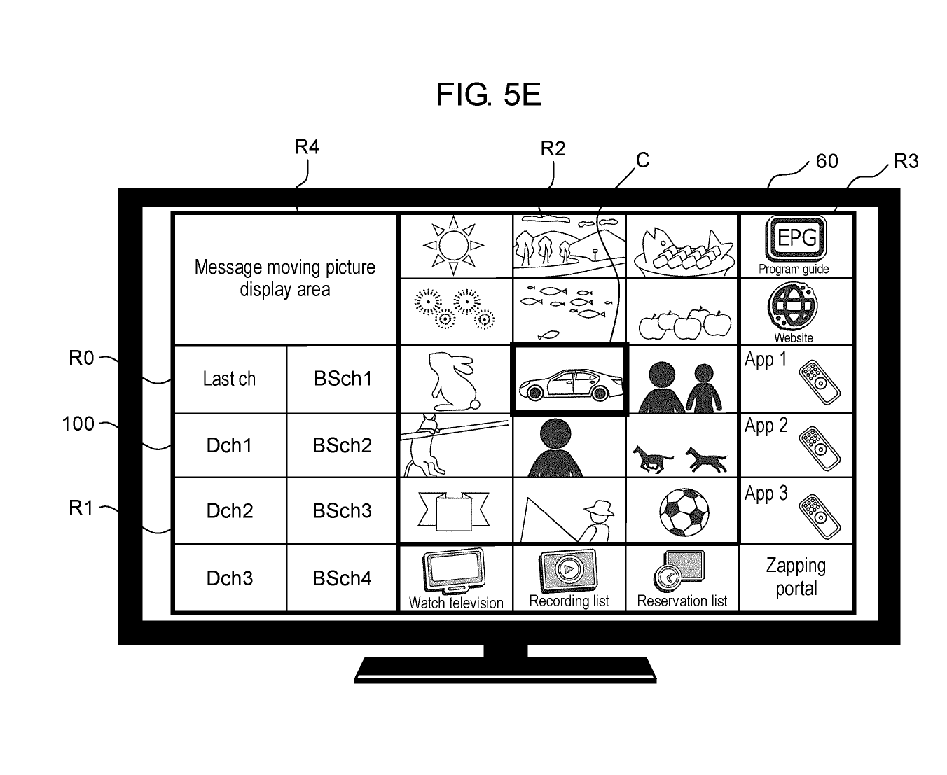

Here, the content browser refers to a piece of software that displays the browser video including the reduced videos on TV 60 to assist the viewer in selecting the service, as illustrated in FIG. 5C. The content browser generates the browser video from the reduced videos of the services, moving picture content, and icon videos. The viewer operates the cursor indicated in the browser video displayed on TV 60 to select the service, moving picture content, or icon video indicated by the cursor.

For example, when the service indicated by the cursor is the first service, the content browser provides the first browser video that does not display the reduced videos of other services while the reduced videos of the first service (hereinafter abbreviated as “first reduced videos”) are displayed. When the service indicated by the cursor is the second service, the content browser provides the second browser video that displays one or more reduced videos of the second service (hereinafter abbreviated as “second reduced videos”) on one screen simultaneously. This makes it possible to provide the content browser according to the above-described permission. In addition, even while the cursor is operated, the moving picture content is displayed in the second aspect (details will be described later).

### [1. Overall Configuration]

First, a configuration of the video receiving apparatus according to the present exemplary embodiment and peripheral devices thereof will be described with reference to FIG. 1 to FIG. 4C. The present exemplary embodiment describes a case where the video receiving apparatus is a set top box (STB) that receives a broadcast wave of cable broadcasting as an example.

FIG. 1 is a diagram illustrating an example of a connection configuration of the video receiving apparatus and peripheral devices thereof. FIG. 1 illustrates STB 20, which is an example of the video receiving apparatus, broadcasting station 10, portal server 30, remote controller 50, television (TV) 60, and moving picture distributing server 70, which are an examples of the peripheral devices.

Note that the broadcast wave of cable broadcasting includes terrestrial digital broadcasting and communication satellite (CS) broadcasting.

In the following exemplary embodiment, a “video” refers to a moving picture, and part of the video may contain a still picture. An “image” refers to a still picture. The “video” and “image” do not include an audio.

### [1-1. Configuration of STB 20 (Video Receiving Apparatus)]

STB 20 receives the broadcast wave from broadcasting station 10, and then outputs the video and audio of the service to be provided to TV 60 in response to an operation of remote controller 50 for STB 20. In addition, STB 20 is connected to portal server 30 and moving picture distributing server 70 via networks 40, such as the Internet and intranet.

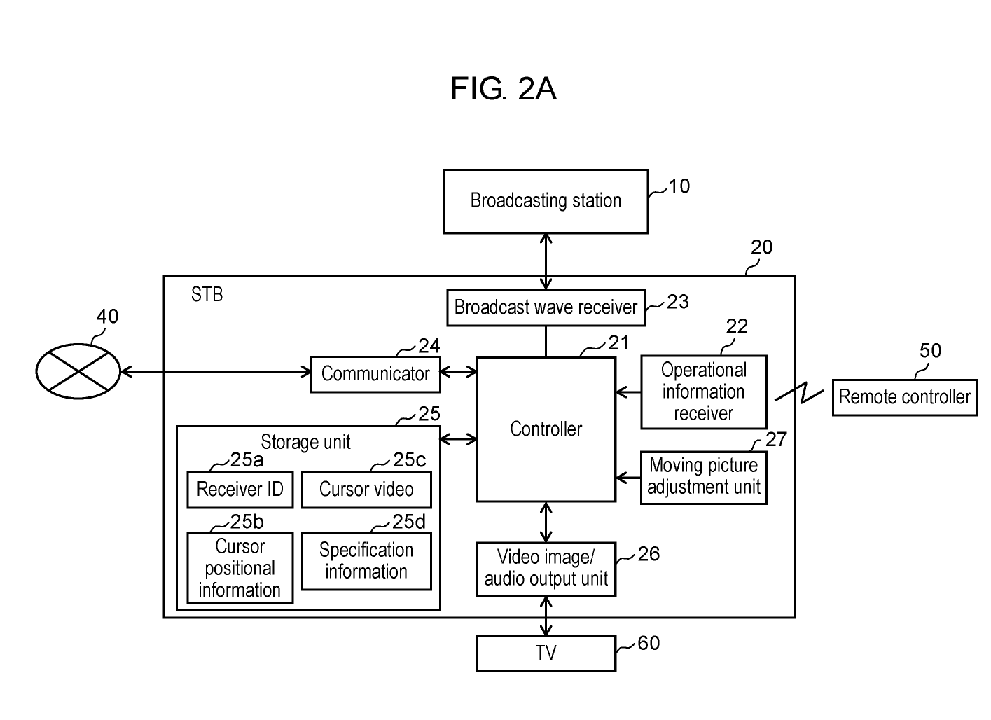

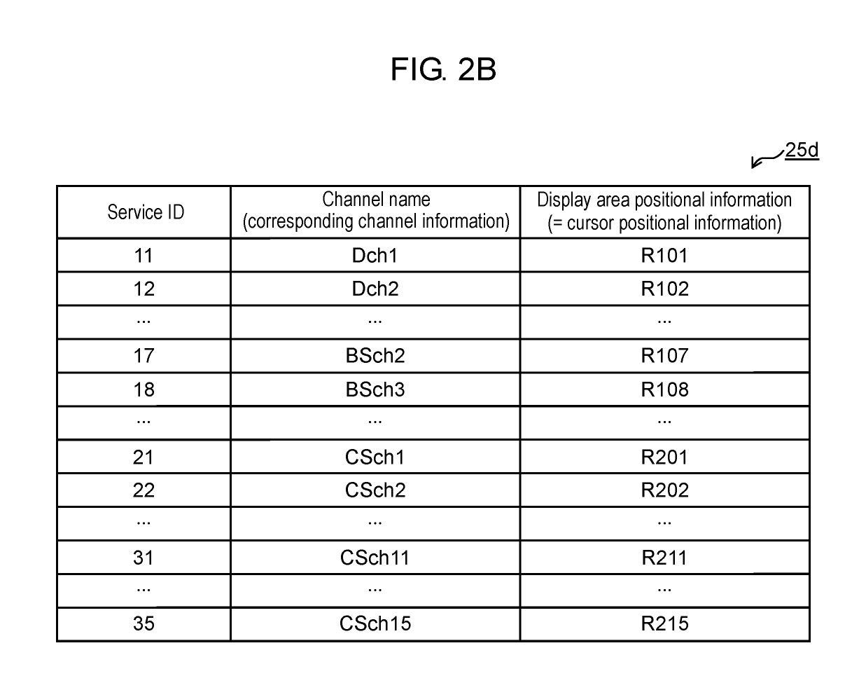

FIG. 2A is a block diagram illustrating an example of a configuration of STB 20. As illustrated in FIG. 2A, STB 20 includes controller 21, operational information receiver 22, broadcast wave receiver 23, communicator 24, storage unit 25, video image/audio output unit 26, and moving picture adjustment unit 27.

Controller 21 controls respective functional units that constitute STB 20. Controller 21 is generally configured using a device such as a CPU (central processing unit) and an arithmetic processor. Controller 21 controls respective functional units that constitute STB 20 by the CPU executing a control program stored in storage unit 25.

Controller 21 outputs the video and audio of the first service, the video and audio of the second service, or the browser video to TV 60 in response to the operation of remote controller 50. When the first service or the second service is selected by the operation of remote controller 50, controller 21 outputs the video and audio of a service extracted by broadcast wave receiver 23 described later from the broadcast wave onto an entire screen of TV 60 (hereinafter may be referred to as a “normal mode”). When the content browser is selected by the operation of remote controller 50, controller 21 activates the content browser, generates the browser video including the list of icon videos, and then outputs the browser video to TV 60. At this time, the moving picture content is displayed in the second aspect in the browser video (details will be described later).

Note that controller 21, video image/audio output unit 26 to be described later, and moving picture adjustment unit 27 constitute a video processor that outputs the moving picture content and the browser video to TV 60 (video display apparatus). The browser video, which will be described in detail later, includes a plurality of first display areas, a plurality of second display areas, an area that displays the moving picture content in the second aspect, and the cursor that points at one of these areas. The first display areas display the first reduced videos obtained by reduction of corresponding videos of the first service. The second display areas display the second reduced videos obtained by reduction of corresponding videos of the second service.

In the present exemplary embodiment, operational information receiver 22 includes an infrared communicator, and receives a signal that indicates a depressed key from remote controller 50 to be described later by infrared communication. Operational information receiver 22 outputs information on the key indicated by the received signal to controller 21.

Broadcast wave receiver 23 is an example of a service receiver that receives a reduced video group and multiplexed audio from broadcasting station 10, which is an example of the peripheral device. Broadcast wave receiver 23 includes a tuner that decodes the video and audio of the service instructed by controller 21 from the broadcast wave. Note that one tuner can extract the video and audio of one service from the broadcast wave at identical time. Broadcast wave receiver 23 outputs the extracted video and audio to controller 21.

Communicator 24 performs network communication with portal server 30 or moving picture distributing server 70 via network 40.

Storage unit 25 includes storage devices such as a random access memory (RAM) that stores temporary data used for processing of controller 21, a read only memory (ROM) that stores a control program and the like, and a hard disk drive used for recording the services.

Storage unit 25 stores receiver ID 25a for identifying STB 20, cursor positional information 25b in the content browser, cursor video 25c, which is a video of the cursor, and specification information 25d, which determines specification of the content browser. Note that although the present exemplary embodiment describes a case where storage unit 25 is incorporated in STB 20, storage unit 25 is not limited to this example. Storage unit 25 may be an externally connected storage device, such as a hard disk drive, and the incorporated storage device and externally connected storage device may be combined and used.

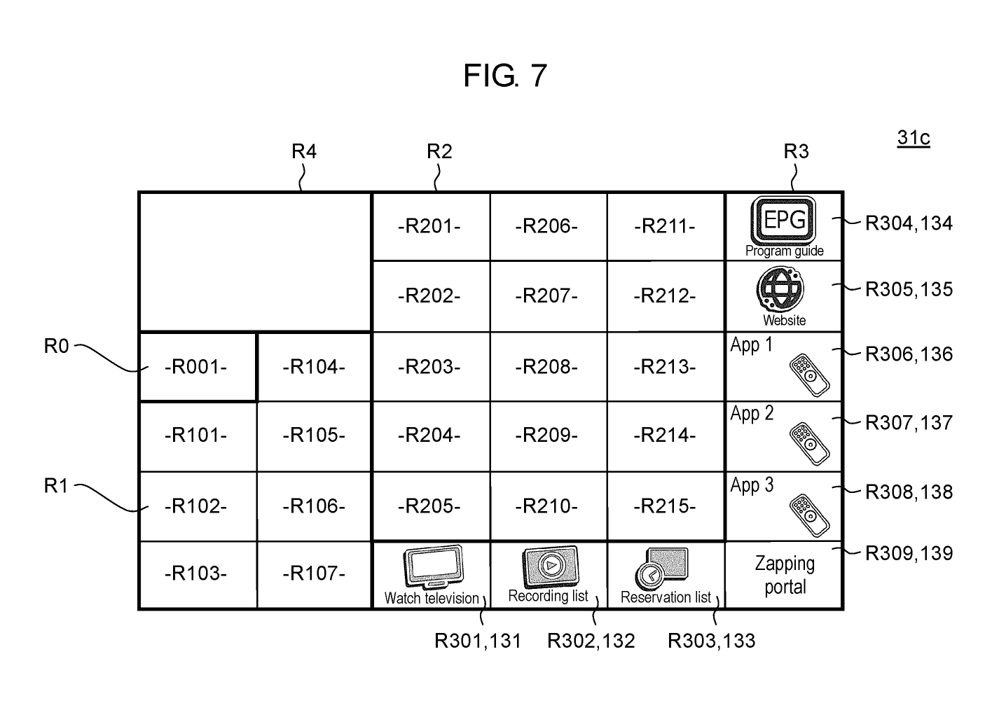

Cursor positional information 25b is information that indicates one of areas that display the plurality of icon videos and moving picture content included in the browser video in the present exemplary embodiment. Cursor positional information 25b is denoted by, for example, display areas R001, R101 to R107, R201 to R215 of FIG. 7 to be described later. The cursor is basically moved between the display areas one at a time in response to one depression of a direction key of remote controller 50 to be described later. Note that cursor positional information 25b may be coordinates or an amount of movement from a reference point. Cursor positional information 25b is initialized to a position of an upper-left display area among the plurality of display areas at a time of display start of the browser video. Subsequently, every time a cursor movement request (a signal indicating that the direction key is depressed) is transmitted from remote controller 50, controller 21 updates cursor positional information 25b to the position according to the movement request transmitted from remote controller 50.

Cursor video 25c is, for example, a frame-shaped figure surrounding the icon video, moving picture content, or the like. As will be described in detail later, in the present exemplary embodiment, since the video such as the icon video and moving picture content have different sizes, cursor video 25c is also a rectangular frame with a size according to the size of the video such as the icon video. Cursor video 25c may be stored as an image such as a bitmap format image. When cursor video 25c is the above-described rectangle, cursor video 25c may be represented by data such as a length of a long side, a length of a short side, and a color and thickness of lines. Note that cursor video 25c may be a moving picture, and may be a still picture. In addition, a shape of cursor video 25c is not limited to the frame-shaped figure, but may differ according to the position of the cursor.

Specification information 25d is information that indicates in which display area to display the reduced video of each of the plurality of services, from among the plurality of first display areas and the plurality of second display areas in the browser video. In other words, specification information 25d is information that indicates at which position to display the reduced video of each service. In addition, specification information 25d may include information that indicates at which position to display the moving picture content.

FIG. 2B is a diagram illustrating an example of specification information 25d according to the present exemplary embodiment. As illustrated in FIG. 2B, specification information 25d includes service IDs uniquely assigned to respective services, channel names of respective services, and positional information that indicates the positions of the display areas that display the reduced videos of respective services (hereinafter abbreviated as “display area positional information” as needed). The display area positional information corresponds to the positional information on first display areas R101 to R107, second display areas R201 to R215 illustrated in FIG. 7 to be described later. The positional information may be a reference point (for example, coordinates of an upper left corner), and a vertical length and horizontal length (number of pixels), or coordinates of two corners on a diagonal line (for example, coordinates of the upper left corner and coordinates of the lower right corner).

Video image/audio output unit 26 is an interface with TV 60, and outputs the video and audio to TV 60.

Moving picture adjustment unit 27 is a processor that displays the moving picture content in the first aspect until displaying the browser video, and when a predetermined condition is satisfied, moving picture adjustment unit 27 displays continuation of the moving picture content in the second aspect different from the first aspect in part of the browser video. In the present exemplary embodiment, when operational information receiver 22 receives information on activation of the content browser from remote controller 50, moving picture adjustment unit 27 causes TV 60 to display, in the first aspect, the moving picture content transmitted from moving picture distributing server 70. When outputting the moving picture content and the audio related to this moving picture content to TV 60 in the first aspect, moving picture adjustment unit 27 may stop other viewing aspects. Examples of other viewing aspects include a normal-mode viewing aspect of outputting to the entire screen of TV 60 the video and audio of the service extracted by broadcast wave receiver 23 from the broadcast wave, and a viewing aspect such as a viewing reservation screen.

The predetermined condition may be completion of activation of the content browser after operational information receiver 22 receives information on activation of the content browser, and may be completion of generation of a content image. In addition, the predetermined condition may be elapse of arbitrary time longer than time for activation of the content browser.

In addition, moving picture adjustment unit 27 displays information regarding the content browser, by superimposing the information on the moving picture content displayed in the first aspect, or at a position different from the position of the moving picture content. Here, the information regarding the content browser refers to at least one of time until the content browser is activated and an arrival rate until the content browser is activated completely. Also, the information regarding the content browser refers to a progress bar displayed together with such indices or displayed independently. In addition, the information regarding the content browser may be the elapsed time and elapsed rate to arbitrary time in the predetermined condition, and may be a progress bar that indicates these indices.

### [1-2. Configuration of Broadcasting Station]

Broadcasting station 10 generates the broadcast wave that transmits the plurality of first services, the plurality of second services, and the service including the reduced video group and multiplexed audio for generating the content browser. Broadcasting station 10 then outputs the generated broadcast wave to STB 20.

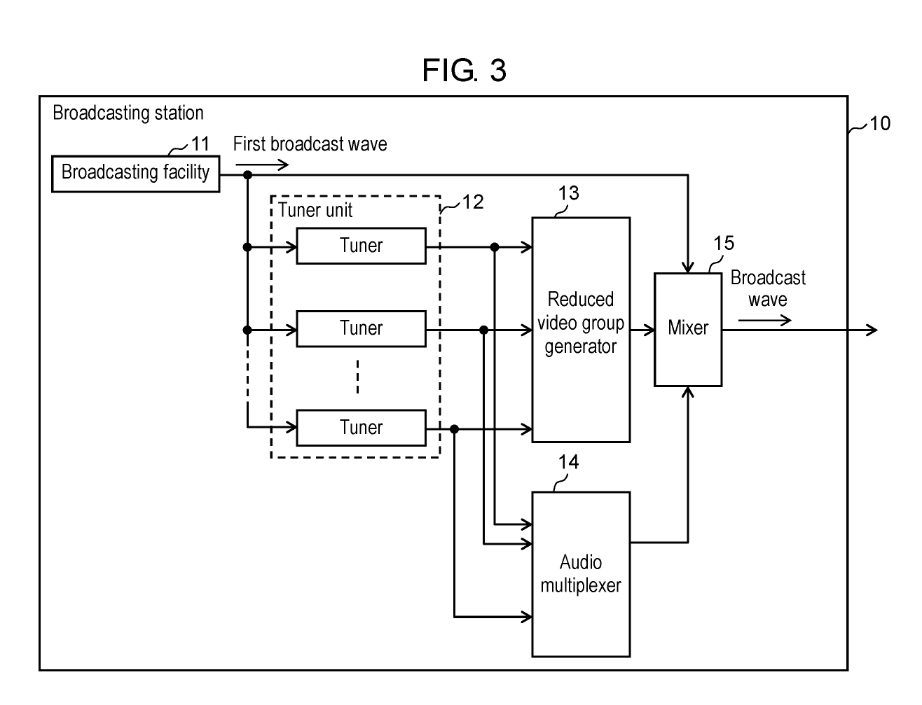

FIG. 3 is a block diagram illustrating an example of a configuration of broadcasting station 10 according to the present exemplary embodiment. As illustrated in FIG. 3, broadcasting station 10 includes broadcasting facility 11, tuner unit 12, reduced video group generator 13, audio multiplexer 14, and mixer 15.

Broadcasting facility 11 is a facility that generates a first broadcast wave including the plurality of first services and the plurality of second services. Broadcasting facility 11 does not need to include only one facility.

Tuner unit 12 includes a plurality of tuners. Each of the plurality of tuners decodes a video and audio of a corresponding service, for example, from the first broadcast wave. A number of the plurality of tuners included in tuner unit 12 does not need to be identical to a total number of the first services and the second services, or to a number of services used for generation of the browser video.

Reduced video group generator 13 generates the reduced video group including the plurality of reduced videos by using the videos of the plurality of services that are output from tuner unit 12. Details of the reduced video group will be described later.

Audio multiplexer 14 multiplexes the audios of the plurality of services that are output from the plurality of tuners that constitute tuner unit 12 to generate the multiplexed audio.

Mixer 15 mixes the reduced video group generated by reduced video group generator 13 and the multiplexed audio generated by audio multiplexer 14 to generate one service. Furthermore, mixer 15 superimposes the generated service on the first broadcast wave that is transmitted from broadcasting facility 11 to generate the broadcast wave. Mixer 15 transmits the broadcast wave to STB 20.

### [1-3. Configuration of Portal Server 30]

Portal server 30 is a server that stores information necessary for providing the content browser, and that outputs to STB 20 information indicated by an information acquisition request in response to the information acquisition request from STB 20. Portal server 30 is communicatively configured with STB 20 via general network 40.

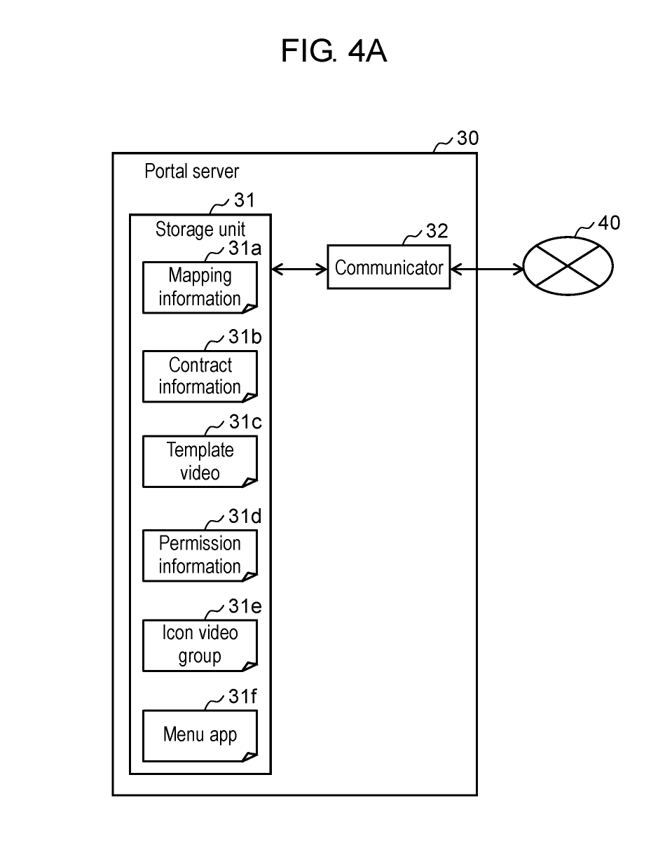

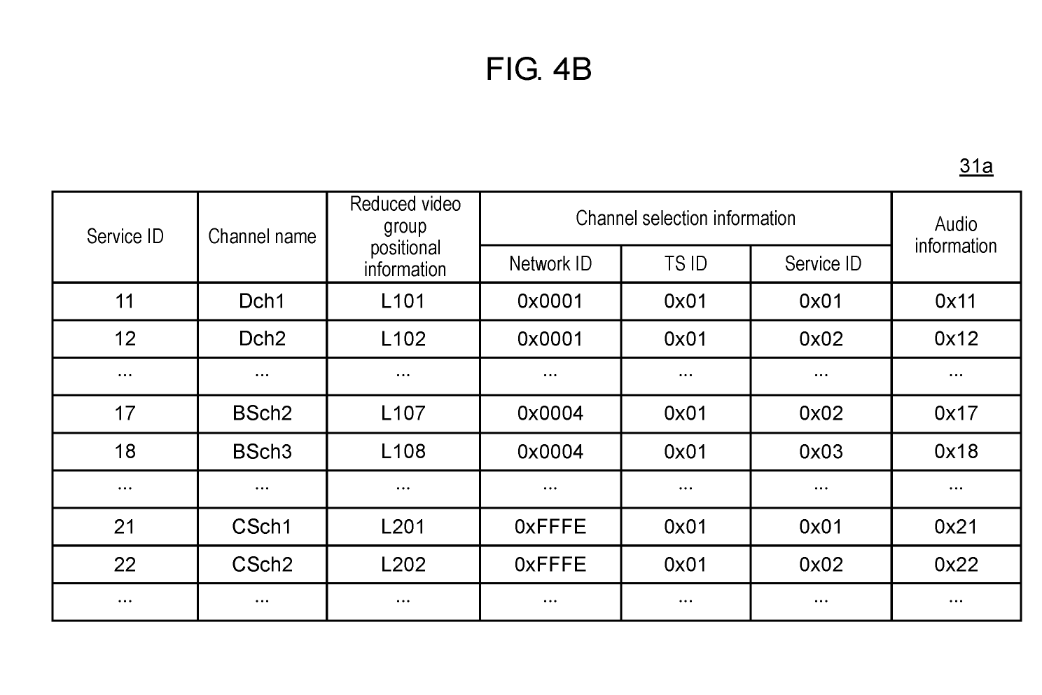

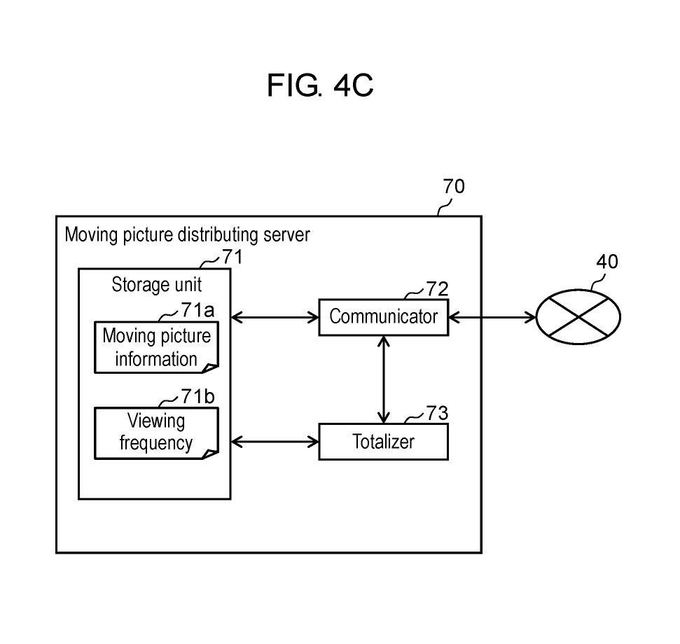

FIG. 4A is a block diagram illustrating an example of a configuration of portal server 30 according to the present exemplary embodiment. Portal server 30 includes storage unit 31 and communicator 32, as illustrated in FIG. 4A.

Storage unit 31 includes a RAM, a ROM, and a hard disk drive. In the present exemplary embodiment, storage unit 31 stores mapping information 31a, contract information 31b, template video 31c, permission information 31d, icon video group 31e, and menu app 31f.

Mapping information 31a is information that indicates, for each of the plurality of services, the position of the reduced video of the service in the reduced video group (corresponding to the position of the cursor).

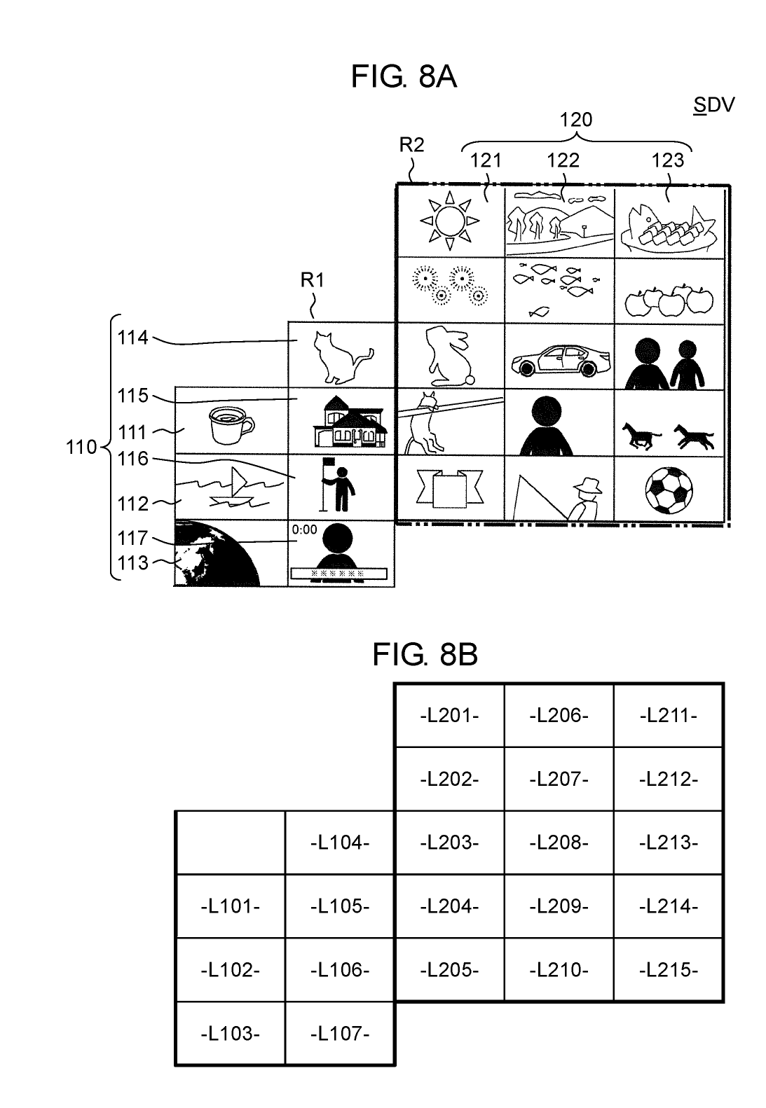

FIG. 4B is a diagram illustrating an example of mapping information 31a according to the present exemplary embodiment. As illustrated in FIG. 4B, mapping information 31a includes, for each of the services, a service ID uniquely assigned to each service, channel name, and positional information that indicates the position of the reduced video of the service in the reduced video group (hereinafter abbreviated as “reduced video positional information” as needed). The reduced video positional information corresponds to the positional information on reduced video application regions L101 to L111, L201 to L215 illustrated in FIG. 8B to be described later. The positional information may be, for example, the reference point (for example, the coordinates of the upper left corner), and the vertical length and horizontal length (number of pixels), or the coordinates of two corners on a diagonal line (for example, the coordinates of the upper left corner and the coordinates of the lower right corner).

Furthermore, mapping information 31a stores channel selection information including a network ID, transport stream (TS) ID, and service ID of the channel, and audio information for extracting the audio corresponding to the channel from the multiplexed audio. The network ID indicates a network type, such as terrestrial digital broadcasting and BS broadcasting, while the TS ID and service ID indicate types of service.

Contract information 31b includes information that indicates whether each of the plurality of services is a contract-required service that requires a contract for viewing. Regarding the contract-required service, contract information 31b further stores information about whether the contract-required service has been contracted for each receiver ID 25a (for each viewer).

Template video 31c is a video that indicates designs of the first browser video and the second browser video. Details of template video 31c will be described later.

Permission information 31d stores information about whether each of the plurality of services is the first service that has no permission for simultaneous display of the reduced video with other services on one screen, or whether each of the plurality of services is the second service that has the permission. Although the present exemplary embodiment describes a case where terrestrial digital broadcasting is the first service and CS broadcasting is the second service for description, the present exemplary embodiment is not limit to this example.

Icon video group 31e includes the plurality of icon videos. The plurality of icon videos includes an icon video for concealing the first reduced videos or the second reduced videos. The icon videos include, for example, a video that indicates the channel of each service, or a video that indicates that the contract-required service is not contracted. Each of the icon videos may be a video including a figure or text, and may be a still picture. The icon video is a video different from the reduced video of the corresponding service. The icon video may be, for example, text or a figure that indicates information on the corresponding service (such as a service name, a logo of the service or a broadcaster that provides the service, a character of the broadcaster, and a channel number).

Menu app 31f is application data for displaying a recording list, reservation list, EPG, website, and the like. Menu app 31f may include other application data, such as a game.

Communicator 32 communicates with communicator 24 of STB 20 via network 40.

### [1-4. Configuration of Remote Controller]

Remote controller 50 is a device for operating STB 20. In the present exemplary embodiment, remote controller 50 includes, on an enclosure surface thereof, a plurality of keys such as a channel selection key to which the content browser is assigned, a ch key to which the first service or the second service is assigned, vertical and horizontal direction keys, a decision key, a power key, and a recording key. Remote controller 50 is provided, inside the enclosure, with a key input detection circuit that detects a depressed key and an infrared communicator (not illustrated) that outputs a signal indicating the detected key by infrared communication.

### [1-5. Configuration of TV]

TV 60 is an example of the video display apparatus, and is, for example, a liquid crystal television or an organic electroluminescent (EL) television. TV 60 includes a display screen that displays videos and an audio output device that outputs sound such as a speaker.

TV 60 receives a decoded video signal and audio signal from STB 20, and then displays the video and outputs the audio.

### [1-6. Configuration of Moving Picture Distributing Server]

Moving picture distributing server 70 is a server that stores the moving picture content acquired from an advertiser, a broadcaster, or the like, and that outputs the moving picture content to STB 20 and the like sequentially or in response to the information acquisition request from STB 20. Moving picture distributing server 70 is communicatively configured with STB 20 via general network 40.

FIG. 4C is a block diagram illustrating an example of a configuration of moving picture distributing server 70 according to the present exemplary embodiment. As illustrated in FIG. 4C, moving picture distributing server 70 includes storage unit 71, communicator 72, and totalizer 73.

Communicator 72 communicates with communicator 24 of STB 20 via network 40.

Totalizer 73 is a processor that acquires information regarding the moving picture content that is output from the plurality of STBs 20 connected to network 40 via communicator 72, and then totals viewing frequency of each type of moving picture content.

Storage unit 71 includes a RAM, a ROM, and a hard disk drive. In the present exemplary embodiment, storage unit 71 stores moving picture information 71a and viewing frequency 71b.

Moving picture information 71a is a plurality of pieces of the moving picture content, and information associated with the moving picture content including an ID, advertiser, merchandise category, output time zone, and target age group.

Viewing frequency 71b is information that indicates viewing frequency of the moving picture content totaled by totalizer 73.

### [2. Operation]

The operation of STB 20 will be described with reference to FIG. 5A to FIG. 10D. In addition to the normal mode, a changeover mode, a standby mode, and a channel selection mode, STB 20 operates in a plurality of operational modes including a recording mode and an app mode. Note that the operation in the recording mode and the operation in other operational modes may be performed simultaneously.

In the normal mode, STB 20 outputs the received first service or second service to be displayed on the entire screen of TV 60.

In the changeover mode, STB 20 outputs the moving picture content in the first aspect.

In the channel selection mode, STB 20 causes TV 60 to display the browser video including a screen for allowing selection of one or more services from the first service and the second service, and the moving picture content of the second aspect.

In the recording mode, STB 20 records one or more services selected from the plurality of services including the content browser, the first service, and the second service.

In the app mode, STB 20 acquires selected application data from portal server 30, and then performs the application data.

### [2-1. Normal Mode]

In the normal mode, STB 20 acquires the video and audio of the service to view from the broadcast wave by using the tuner of broadcast wave receiver 23. STB 20 then outputs the acquired video and audio from video image/audio output unit 26 to TV 60. In this case, as illustrated in FIG. 5A, STB 20 outputs the video so that the video of the service may be displayed on the entire screen of TV 60.

This allows TV 60 to display, on the screen thereof, the video of the service included in one of the previously selected first service and second service. In addition, the (unillustrated) speaker of TV 60 outputs the audio that agrees with the displayed video.

### [2-2-1. Changeover Mode]

In the changeover mode, STB 20 outputs specific moving picture content acquired from moving picture distributing server 70, from video image/audio output unit 26 to TV 60, until the browser video is displayed. In this case, as illustrated in FIG. 5B, STB 20 outputs the video so that moving picture content V1 of the first aspect may be displayed. In addition, STB 20 may output the audio that agrees with moving picture content V1 that is being displayed.

Here, the first aspect is an aspect in which the viewer may recognize that the video is displayed in a mode different from the normal mode. For example, as illustrated in FIG. 5B, the first aspect is an aspect in which a frame such as a rectangle is provided in part of TV 60, and moving picture content V1 is displayed within the frame. In addition, such aspects may be considered as an aspect in which moving picture content V1 is displayed in part of the screen of TV 60, and an aspect in which moving picture content V1 is displayed on the entire screen of TV 60 and information regarding the content browser, such as progress bar P, is superimposed and displayed on moving picture content V1.

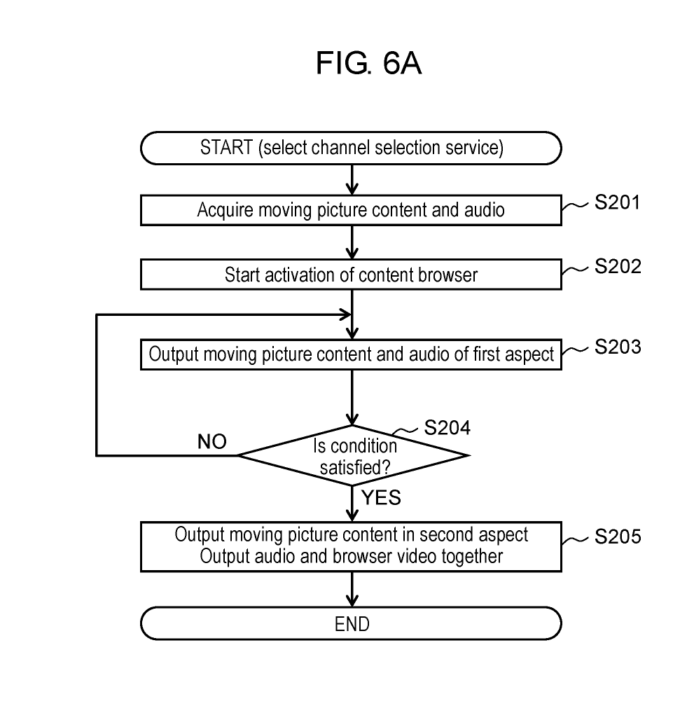

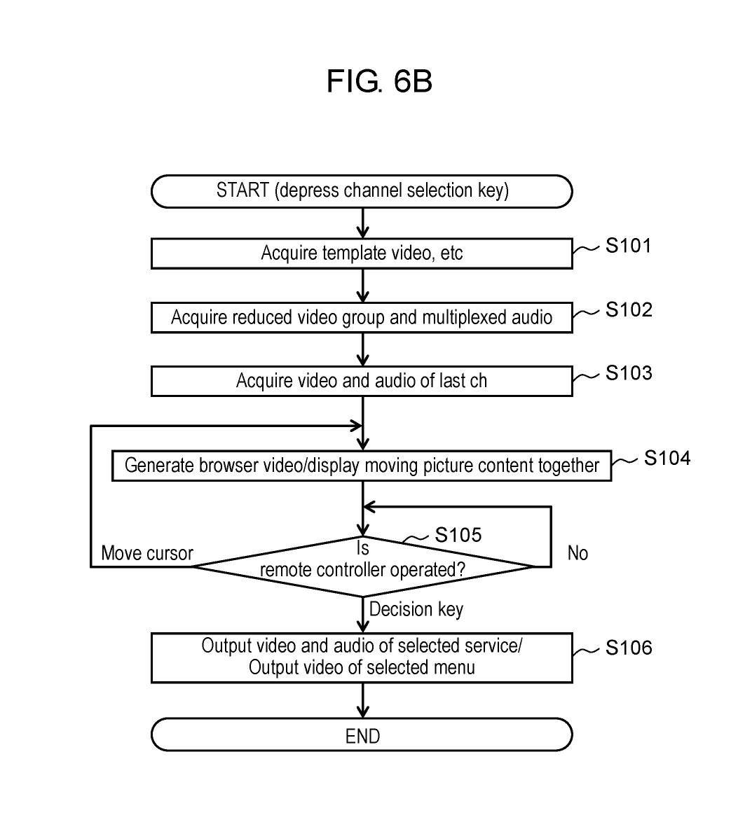

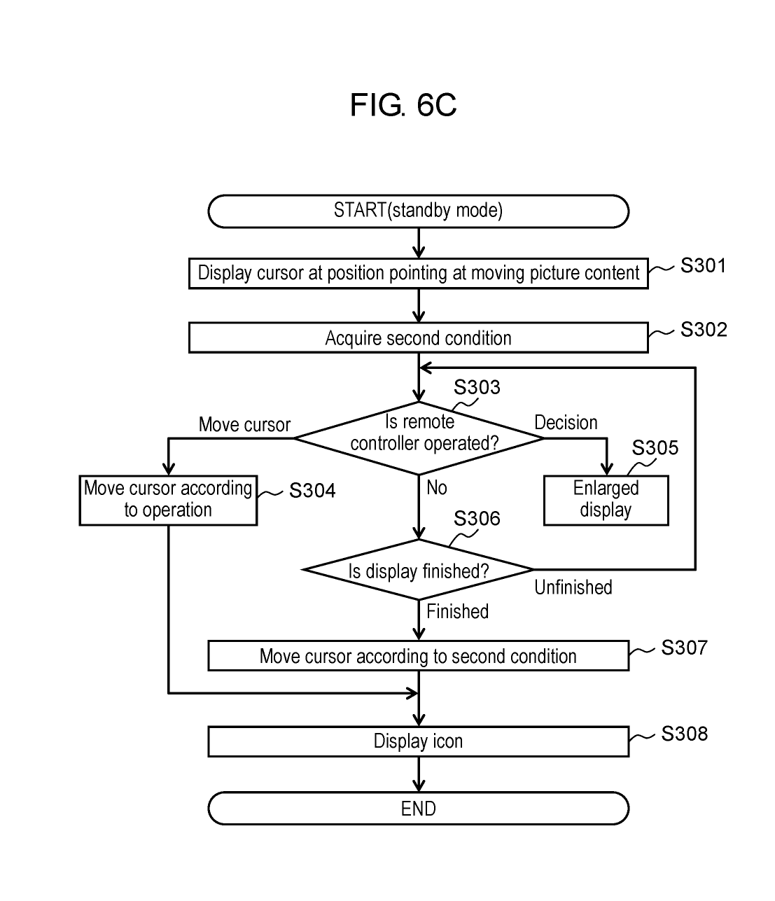

FIG. 6A is a flowchart illustrating a flow of processing in the changeover mode.

As illustrated in FIG. 6A, when the channel selection key of remote controller 50 is depressed to select the channel selection service with the power of STB 20 turned on, STB 20 transitions to the changeover mode. Note that preparation for the transition to the channel selection mode starts in background of the changeover mode (refer to S101 to S103 in FIG. 6B to be described later).

After the transition to the changeover mode, moving picture adjustment unit 27 acquires moving picture content V1 and the audio from moving picture distributing server 70 via communicator 24 (S201).

Next, controller 21 reads software from storage unit 25 and then starts activation of the content browser (S202).

Next, STB 20 causes TV 60 to display moving picture content V1 of the first aspect, as illustrated in FIG. 5B. Simultaneously, STB 20 outputs the audio corresponding to moving picture content V1. Along with moving picture content V1, STB 20 may display progress bar P, which is information regarding an activation state of the content browser.

STB 20 determines whether the predetermined condition is satisfied (S204). Specifically, for example, while the content browser is being activated (S204: NO), STB 20 continues outputting moving picture content V1 of the first aspect. On receipt of information that activation of the content browser is completed (S204: YES), STB 20 moves to a next step.

The condition may be a time period after the channel selection service is selected. For example, the condition may be that one minute has elapsed after the channel selection service is selected. In addition, the condition may be, for example, ten seconds after activation of the content browser is completed.

As the next step, as illustrated in FIG. 5C, STB 20 outputs moving picture content V2 of the second aspect, and at the same time, STB 20 outputs continuation of the audio of the moving picture content and the browser video (S205).

Note that a changeover period may be included while STB 20 moves from S204 to S205. For example, in the changeover period, STB 20 may display a fade-out of the screen in the changeover mode, and subsequently, STB 20 may move to S205 and then display the browser video. In the present disclosure, the changeover period may be regarded as part of the changeover mode or part of the browser video.

In addition, in the above-described changeover period, STB 20 does not necessarily need to display the moving picture content. Even when the moving picture content is not displayed in the changeover period, STB 20 may continue to output only the audio of the moving picture content.

Note that S104 illustrated in FIG. 6B corresponds to output of the browser video (details will be described later).

### [2-2-2. Standby Mode]

FIG. 6C is a flowchart illustrating a flow of processing in the standby mode.

The standby mode is a mode of controlling a transition of the cursor at a time of outputting moving picture content V2 of the second aspect. In the standby mode, as illustrated in FIG. 5D instead of FIG. 5C, STB 20 outputs moving picture content V2 of the second aspect, and displays cursor C pointing at moving picture content V2 displayed in the second aspect (S301). In the present exemplary embodiment, as illustrated in FIG. 5D, cursor C is a relatively thick frame-shaped image surrounding an outer periphery of moving picture content V2. A display of cursor C (S301) is performed in parallel with output of moving picture content V2, and with output of the audio of moving picture content V2 (refer to S205 in FIG. 6A).

Next, controller 21 acquires a second condition (S302). Here, the second condition is information that indicates another position to which cursor C should be moved from the position that points at moving picture content V2. Information previously stored in storage unit 25 may be acquired as the second condition. The second condition may also be acquired from moving picture distributing server 70 or portal server 30 via communicator 24. Moving picture distributing server 70 or portal server 30 may change content of the second condition to transmit according to moving picture content V2 that is being output. Furthermore, the second condition may be acquired not only at a stage of step S302 but also before step S301.

Next, when the direction key of remote controller 50 is depressed (“move cursor” in S303), STB 20 moves cursor C according to the depressed direction key (S304). When the decision key of remote controller 50 is depressed (“decision” in S303), STB 20 displays moving picture content V2 in an aspect larger than the second aspect (for example, full screen), and then exits from the flow (S305). In contrast, if remote controller 50 is not operated (“No” in S303), STB 20 moves to the next step.

Next, controller 21 determines whether moving picture content V2 has been finished (S306). If moving picture content V2 has not been finished (“unfinished” in S306), controller 21 returns to the step of checking the operation of remote controller 50 again (S303). On the one hand, when moving picture content V2 has been finished (“finished” in S306), controller 21 moves cursor C that is pointing at moving picture content V2 to, for example, the position illustrated in FIG. 5E in accordance with the acquired second condition (S308).

Here, examples of the second condition include:

i) move cursor C to the position that indicates last ch, which is the service broadcasted immediately before the browser video is displayed;

ii) move cursor C to an area that displays the reduced video of the service specified by moving picture distributing server 70 because of a relationship with moving picture content V2;

iii) move cursor C to an area related to the service recommend by portal server 30; and

iv) move cursor C to an area related to an original intention to activate the content browser.

Next, when cursor C that is pointing at moving picture content V2 moves to another place, STB 20 displays, in area R4 that has displayed moving picture content V2, an icon video indicating that area R4 is an area for displaying moving picture content V2 as illustrated in FIG. 5E (S308).

Here, the icon video indicating that area R4 is an area for displaying moving picture content V2 refers to a moving picture or still picture different from moving picture content V2 of the second aspect. For example, the icon video is an image that indicates only text such as “message moving picture display area”.

### [2-3. Channel Selection Mode]

FIG. 5C is a diagram illustrating an example of TV 60 that displays the browser video according to the present exemplary embodiment. FIG. 6B is a flowchart illustrating a procedure for displaying the browser video according to the present exemplary embodiment.

### [2-3-1. Acquisition of Data Necessary for Generation of Browser Video]

In STB 20, when the channel selection key is depressed to select the channel selection service while the power of STB 20 is on, preparation for moving to the channel selection mode starts in background of the changeover mode. At this time, controller 21 stores, in storage unit 25, information on the service broadcasted immediately before the browser video is displayed (hereinafter referred to as “last ch” as needed). The information on last ch is, for example, the channel number.

When the preparation for moving to the channel selection mode starts, STB 20 acquires template video 31c, mapping information 31a, contract information 31b, permission information 31d, and icon video group 31e that serve as a base of the browser video, from portal server 30 via communicator 24 (S101).

FIG. 7 is a diagram illustrating an example of template video 31c according to the present exemplary embodiment. As illustrated in FIG. 7, template video 31c includes areas R0 to R3 and content area R4 that displays moving picture content V2 of the second aspect (the area surrounded by a thick line of FIG. 7).

Area R0 includes one display area R001 that displays the reduced video of last ch.

Area R1 includes first display areas R101 to R107 which are identical in shape and size. In the present exemplary embodiment, each of first display areas R101 to R107 is an area that displays the reduced video of terrestrial digital broadcasting and BS digital broadcasting.

Area R2 includes second display areas R201 to R215 which are identical in shape and size. In the present exemplary embodiment, each of second display areas R201 to R215 is an area that displays the reduced video of CS broadcasting. In the present exemplary embodiment, second display areas R201 to R215 are identical to first display areas R101 to R107 in shape and size.

Note that for description, the present exemplary embodiment describes a case where terrestrial digital broadcasting and BS broadcasting are the first service (the service that has no permission for simultaneous display of the reduced video of the service with other reduced videos on one screen), and where CS broadcasting is the second service (the service that has the permission). However, the present exemplary embodiment is not limited to this example.

Area R3 includes third display areas R301 to R309. In the present exemplary embodiment, third display areas R301 to R305 are areas that display icon videos 131 to 135 that indicate preset menu apps, respectively. Third display areas R306 to R308 are areas that display icon videos 136 to 138 that indicate menu apps registered by the viewer, respectively. Third display area R309 is an area that displays icon video 139 indicating a company that provides STB 20.

Note that the present exemplary embodiment describes an example in which the icon videos have already been combined with template video 31c in advance in area R3. However, the present exemplary embodiment is not limited to this example. STB 20 may be configured to acquire template video 31c with icon videos not combined in area R3 and icon videos 131 to 139, and then to combine these icon videos when generating the browser video of step S104 to be described later.

In more detail, third display area R301 has an insertion of icon video 131 for “watch television”, that is, icon video 131 for returning to the normal mode before the browser video is displayed. Third display area R302 has an insertion of icon video 132 for displaying the recording list. Third display area R303 has an insertion of icon video 133 for displaying the reservation list. Third display area R304 has an insertion of icon video 134 for displaying the program guide. The program guide is, for example, the EPG and is a service different from the content browser. Third display area R305 has an insertion of icon video 135 for displaying the website (website of the company that provides STB 20).

The configuration of icon videos 131 to 139 respectively displayed in third display areas R301 to 309, that is, a number, type, etc. of so-called menu apps are not limited to this example.

In addition, the configuration of areas R1 to R4 is not limited to this example. The configuration such as a size and shape of each area, and a number of display areas may be arbitrarily determined. Note that in the following description, display areas R001, R101 to R107, R201 to R215, R301 to R309 illustrated in FIG. 7 may be used for indicating the positions of the display areas. Although reference symbols corresponding to the display areas may be omitted in diagrams other than FIG. 7, the reference symbols provided in the display areas indicated in the positions identical to the display areas in FIG. 7 correspond thereto.

STB 20 acquires the service including data for generating the content browser (reduced video group and multiplexed audio) from the broadcast wave transmitted from broadcasting station 10 by using the tuner of broadcast wave receiver 23 (S102).

FIG. 8A is a diagram illustrating an example of reduced video group SDV according to the present exemplary embodiment. FIG. 8B is a diagram illustrating a relationship between the plurality of reduced videos included in reduced video group SDV and application regions thereof according to the present exemplary embodiment.

Reduced video group SDV illustrated in FIG. 8A includes the plurality of first reduced videos and the plurality of second reduced videos. Although the position of each reduced video corresponds to the position in the content browser for description in FIG. 8A, the position of each reduced video does not necessarily need to correspond to the position in the content browser.

In reduced video group SDV illustrated in FIG. 8A, first reduced videos 111 to 117 included in first reduced video group 110 are pasted on application regions L101 to L107 illustrated in FIG. 8B, respectively. In addition, in reduced video group SDV illustrated in FIG. 8A, the plurality of second reduced videos included in second reduced video group 120 are pasted on application regions L201 to L215 illustrated in FIG. 8B, respectively.

Second reduced video 121 is herein a reduced video of a non-contracted service among the contract-required services that require a contract for viewing. As will be described in detail later, the icon video indicating that the video is not contracted is combined on the reduced video in generation of the browser video to be described later, in order to prevent the reduced video from being displayed. Second reduced video 122 is herein the reduced video of the contracted service among the contract-required services. Second reduced video 123 is the reduced video of the service that does not need a contract for viewing.

Reduced video group SDV may not be one video as illustrated in FIG. 8A, but first reduced video group 110 and second reduced video group 120 may be individually stored in association with the services. In addition, FIG. 8A illustrates a case where a number of CS broadcasting channels is equal to or greater than a number of second display areas R201 to R215, and where the reduced videos are displayed in all second display areas R201 to R215. However, there may be some areas where the reduced videos are not displayed.

STB 20 acquires the reduced video and audio of last ch (S103). STB 20 may acquire the reduced video of last ch from the reduced video group, and may acquire the audio from the multiplexed audio. When acquiring the reduced video of last ch from the reduced video group, controller 21 identifies the position of the reduced video of last ch in the reduced video group from mapping information 31a acquired from portal server 30 in step S101 and from information on last ch stored in storage unit 25. Controller 21 acquires the reduced video of last ch by copying the reduced video of last ch in the reduced video group.

Note that the method for acquiring the reduced video and audio of last ch is not limited to this example. For example, when broadcast wave receiver 23 includes two or more tuners, STB 20 may acquire the video and audio of last ch from the broadcast wave by using a tuner other than a tuner for acquiring the service including data for generating the content browser from the broadcast wave. STB 20 can acquire the reduced video and audio of last ch by performing reduction process on the acquired video of last ch.

### [2-3-2. Generation of Browser Video]

STB 20 generates the browser video and then outputs the generated browser video, moving picture content V2 of the second aspect, and the audio of moving picture content V2 to TV 60 (S104). In addition, when the viewer moves or selects cursor C while the browser video is displayed, STB 20 may output to TV 60 an operational sound or notification sound that indicates the movement or selection.

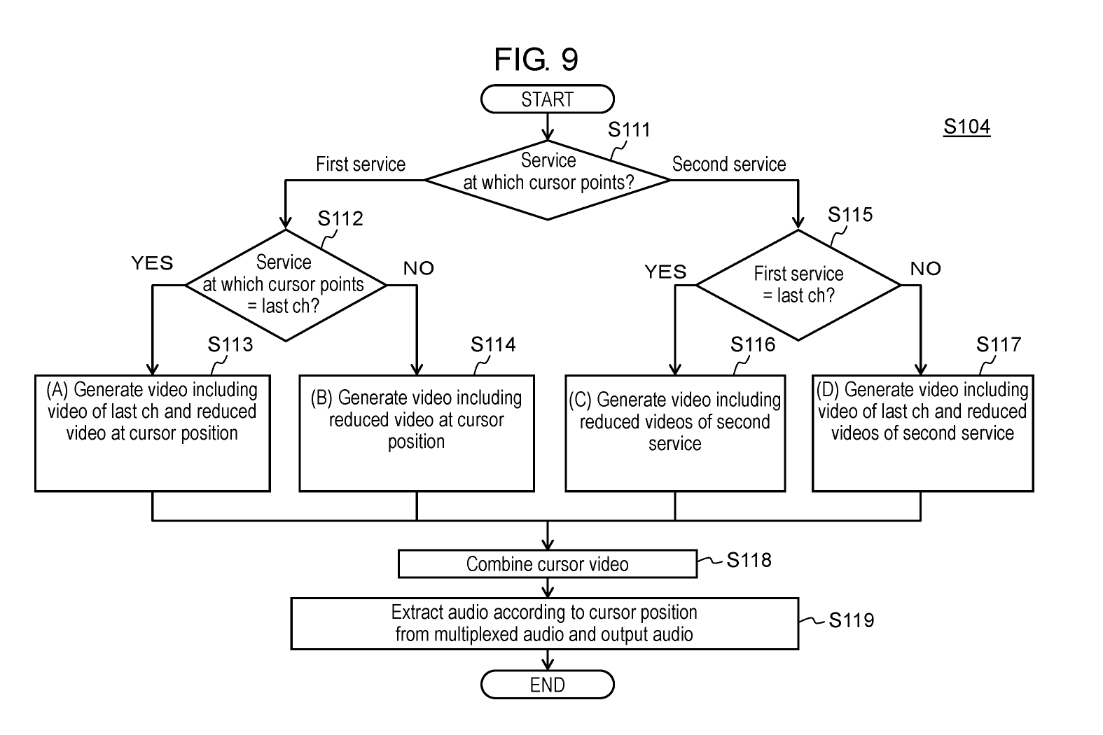

FIG. 9 is a flowchart illustrating an example of a processing procedure of the method for acquiring the browser video and audio according to the present exemplary embodiment.

Controller 21 of STB 20 checks whether the service at which cursor C points is the first service or the second service (S111). The first service is, as described above, the service that does not have permission for simultaneous display of the reduced video with other reduced videos on one screen. The second service is the service that has the permission.

If the service at which cursor C points is the first service, STB 20 displays the first browser video. The first browser video displays the reduced videos of the first service and displays the icon videos that indicate other services.

If the service at which cursor C points is the second service, STB 20 displays the second browser video. The second browser video displays the reduced videos of the second service and displays the icon videos that indicate the first service.

This makes it possible to provide the content browser according to presence of the permission described above.

Note that both of the first browser video and the second browser video may display moving picture content V2 of the second aspect together.

Controller 21 identifies the service at which cursor C points by using cursor positional information 25b stored in storage unit 25 and specification information 25d illustrated in FIG. 2B. For example, when the position of cursor C is the position of display area R001 of last ch, controller 21 identifies the service from the information on last ch stored in storage unit 25. When the position of cursor C is other than the position of last ch, controller 21 identifies the service from cursor positional information 25b (R101 to R107, R201 to R215) stored in storage unit 25, and specification information 25d illustrated in FIG. 2B. For example, when cursor positional information 25b is R107, controller 21 can identify from FIG. 2B that the service at which cursor C points is BSch2. For example, when cursor positional information 25b is R211, controller 21 can identify that the service at which cursor C points is CSch11, from specification information 25d illustrated in FIG. 2B.

Controller 21 checks whether the identified service is the first service or the second service by using permission information 31d acquired from portal server 30 in step S101.

When the service at which cursor C points is the first service (“first service” in S111), controller 21 checks whether the service at which cursor C points is identical to last ch (S112). The service at which cursor C points has already been identified in step S111. Last ch has been stored in storage unit 25 at a time of display start of the content browser. Controller 21 compares these pieces of information to check whether the first service at which cursor C points is identical to last ch.

If the first service at which cursor C points is identical to last ch (“first service=last ch” in S112), controller 21 generates the first browser video that displays last ch and the reduced video of the first service at which cursor C points (S113). The first browser video does not display the reduced videos of other services.

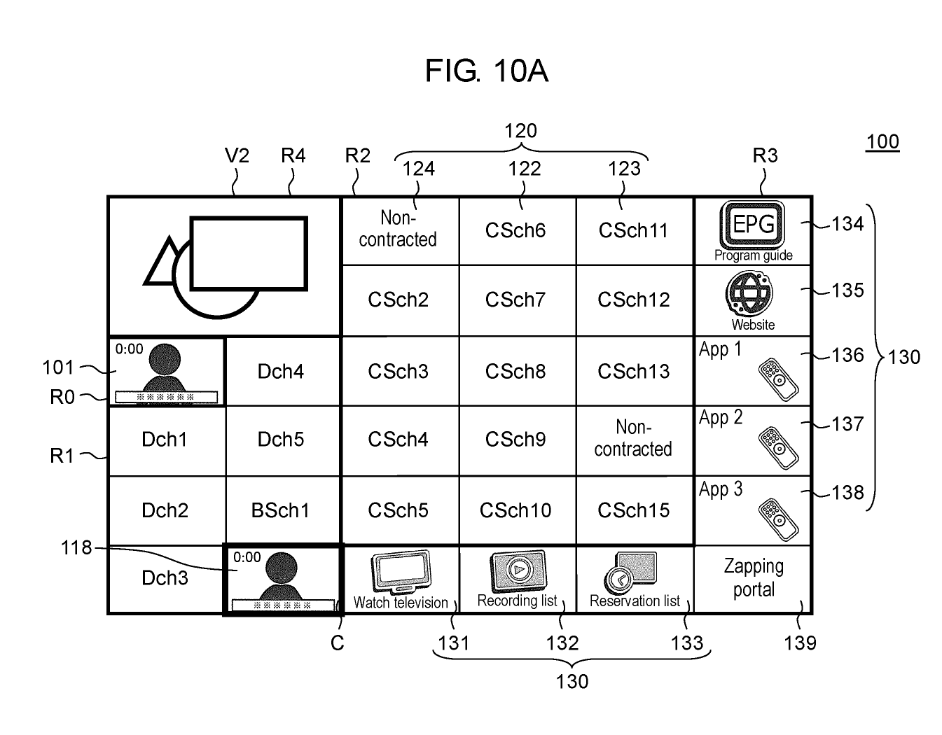

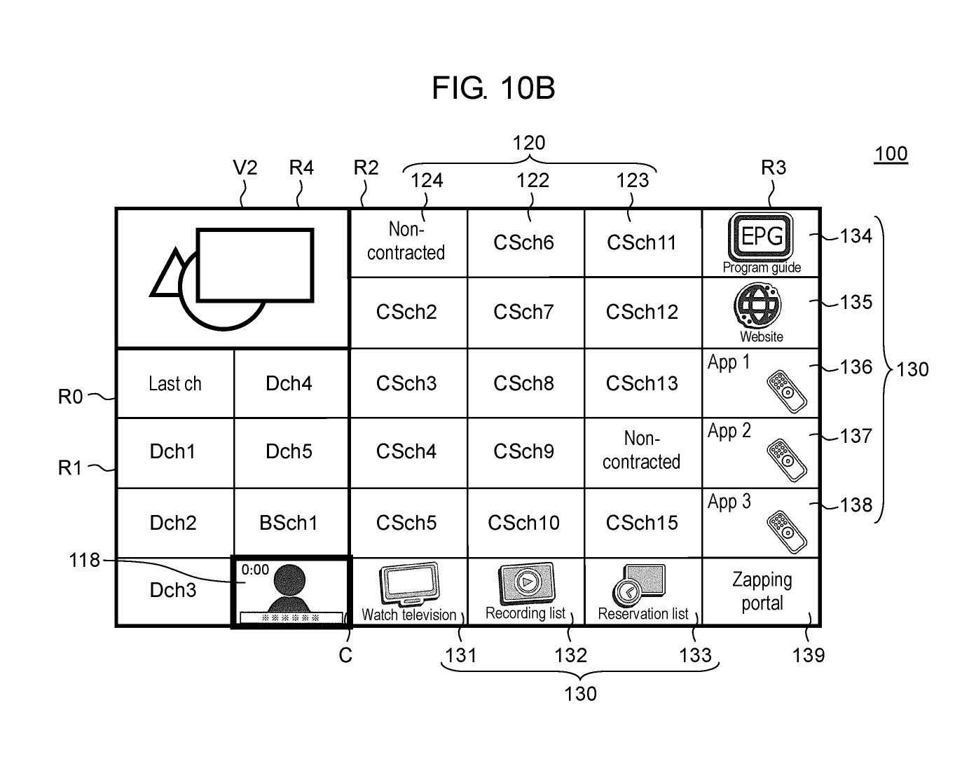

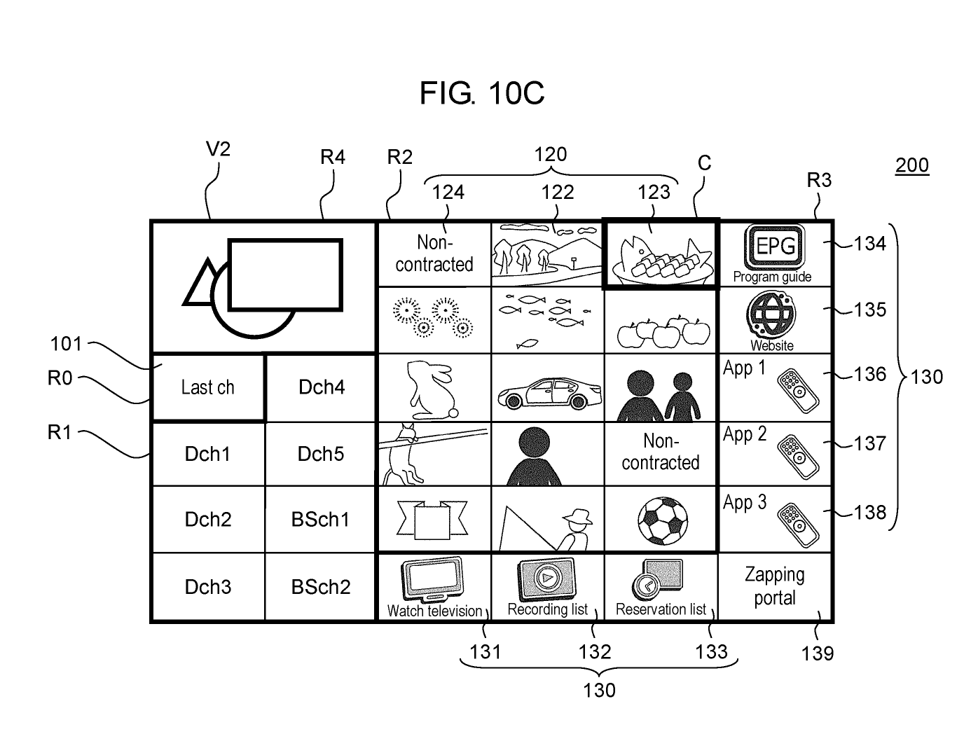

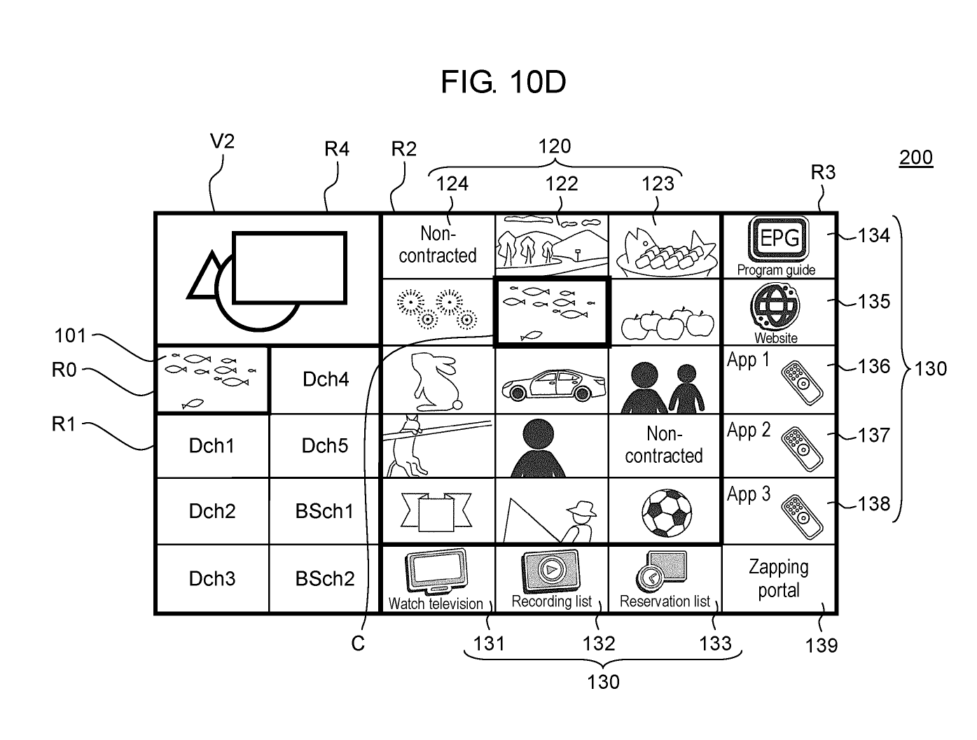

FIG. 10A is a diagram illustrating an example of the video of first browser video 100 according to the present exemplary embodiment. First browser video 100 displays the first reduced video of the first service at which cursor C points, and does not display other reduced videos. In FIG. 10A, in addition to the reduced video of the first service at which cursor C points, first browser video 100 also displays the reduced video of last ch.

In FIG. 10A, the first service at which cursor C points is BSch2. In addition, the service the viewer has lastly viewed is BSch2. Since the first service at which cursor C points is identical to last ch in FIG. 10A, reduced video 101 of last ch and reduced video 118 of BSch2 are displayed. In addition, the display areas of areas R1 and R2 other than BSch2 display the icon videos that indicate the corresponding services as videos different from the corresponding videos (reduced videos).

Controller 21 combines template video 31c with the reduced video group to generate a composite video. When arrangement of respective reduced videos in the reduced video group acquired from the broadcast wave does not agree with arrangement of the reduced video group in specification information 25d, controller 21 rearranges the reduced videos in accordance with specification information 25d. In this case, based on mapping information 31a and specification information 25d, controller 21 rearranges the reduced videos included in the reduced video group illustrated in FIG. 8A into the positions illustrated in specification information 25d. Controller 21 combines the reduced video group after rearrangement with template video 31c to generate the composite video. If the composite video has already been produced in past processing, the already produced composite video may be used.

In the display areas in which the reduced videos are not to be displayed, controller 21 performs so-called mask processing for combining the composite videos with the icon videos. From icon video group 31e acquired from portal server 30 in step S101, controller 21 acquires the icon video corresponding to each of the plurality of display areas included in areas R1 and R2 except first display area R107. Controller 21 combines the composite video with the icon video corresponding to each of the plurality of display areas included in areas R1 and R2 except first display area R107, as a video different from the corresponding video.

In addition, in the display area corresponding to the service that is stored as non-contracted in contract information 31b acquired from portal server 30 in step S101, controller 21 combines the composite video with the icon video indicating that the service is non-contracted, as the video different from the corresponding video. In FIG. 10A, controller 21 combines the composite video with icon video 124 indicating that the service is non-contracted in second display area R201 corresponding to the non-contracted contract-required service. This causes second reduced video 121 illustrated in FIG. 8A to be concealed by icon video 124. Similarly, controller 21 also combines the composite video with icon video 124 indicating that the service is non-contracted on the second reduced video in second display area R214 corresponding to the non-contracted contract-required service. The icon video is not combined in second display area R206 corresponding to the contracted contract-required service, so that second reduced video 122 is displayed indicating the service.

In summary, in the video of first browser video 100 illustrated in FIG. 10A, display area R001 displays the video of last ch. First display areas R101 to R106 display the icon videos corresponding to Dch1 to Dch5, BSch1, respectively. First display area R107 displays the video of BSch2. Second display areas R202 to R213, R215 display the icon videos corresponding to CSch2 to CSch13, CSch15, respectively. Second display areas R201 and R214 display the icon videos indicating that the services are non-contracted.

If the first service at which cursor C points is not identical to last ch (“first service≠last ch” in S112), controller 21 generates first browser video 100 that displays the reduced video of the first service at which cursor C points (S114). First browser video 100 does not display the reduced videos of other services including last ch.

FIG. 10B is a diagram illustrating another example of first browser video 100 according to the present exemplary embodiment. First browser video 100 displays the first reduced video of the first service at which cursor C points and does not display other reduced videos. In FIG. 10B, unlike in FIG. 10A, the reduced video of last ch is not displayed.

In FIG. 10B, the first service at which cursor C points is BSch2. In addition, the service the viewer has lastly viewed is the service other than BSch2, for example, BSch1. Since the first service at which cursor C points differs from last ch in FIG. 10B, reduced video 118 of BSch2 is displayed, whereas the reduced video of last ch is not displayed. The display areas of areas R1 and R2 other than BSch2 display the icon videos that indicate the corresponding services as the videos different from the corresponding videos.

In a similar manner to FIG. 10A, controller 21 combines template video 31c with the reduced video group to generate the composite video. When arrangement of respective reduced videos in the reduced video group acquired from the broadcast wave does not agree with arrangement of the reduced video group in specification information 25d, controller 21 rearranges the reduced videos in accordance with specification information 25d. In this case, after rearranging the plurality of reduced videos included in the reduced video group, controller 21 combines template video 31c with the reduced video group after rearrangement to generate the composite video.

Controller 21 combines the composite video with the icon video corresponding to each of the plurality of display areas included in area R1 and area R2 except first display area R107. In display area R001 included in area R0, controller 21 combines the composite video with the icon video indicating that the area is the display area for the reduced video of last ch. In addition, in the display area corresponding to the service that is stored as non-contracted in contract information 31b acquired from portal server 30 in step S101, controller 21 combines the composite video with the icon video indicating that the service is non-contracted, as the video different from the corresponding video.

In summary, in the video of first browser video 100 illustrated in FIG. 10B, display area R001 displays the icon video indicating that the area is the display area of last ch. First display areas R101 to R106 display the icon videos corresponding to Dch1 to Dch5, BSch1, respectively. First display area R107 displays the video of BSch2. Second display areas R202 to R213, R215 display the icon videos corresponding to CSch2 to CSch13, CSch15, respectively. Second display areas R201 and R214 display the icon videos indicating that the services are non-contracted.

Note that although illustration is omitted, area R4 may display moving picture content V2 of the second aspect.

When the service at which cursor C points is the second service (“second service” in S111), controller 21 checks whether last ch is the first service or the second service (S115). Controller 21 identifies the service from the information on last ch stored in storage unit 25. Controller 21 then checks whether last ch is the first service or the second service by using permission information 31d acquired from portal server 30 in step S101.

When last ch is the first service (“first service” in S115), controller 21 generates the second browser video that displays the plurality of reduced videos of the second service (S116). The second browser video displays neither the reduced video of last ch nor the reduced videos of the first service.

FIG. 10C is a diagram illustrating an example of the video of second browser video 200 according to the present exemplary embodiment. Second browser video 200 displays the plurality of second reduced videos, and does not display the plurality of first reduced videos. In FIG. 10C, the reduced video of last ch is not displayed.

In FIG. 10C, the second service at which cursor C points is CSch11. In addition, the service the viewer has lastly viewed is the first service. In FIG. 10C, since last ch is the first service, the reduced video of last ch is not displayed. In FIG. 10C, second reduced video group 120 is displayed including second reduced video 122 and second reduced video 123.

In a similar manner to FIG. 10A, controller 21 combines template video 31c with the reduced video group to generate the composite video. When arrangement of respective reduced videos in the reduced video group acquired from the broadcast wave does not agree with arrangement of the reduced video group in specification information 25d, controller 21 rearranges the reduced videos in accordance with specification information 25d. In this case, after rearranging the plurality of reduced videos included in the reduced video group, controller 21 combines template video 31c with the reduced video group after rearrangement to generate the composite video.

Controller 21 combines the composite video with the icon videos that indicate Dch1 to Dch5, BSch1, BSch2 in first display areas R101 to R107 included in area R1, respectively, as videos different from the corresponding videos. In display area R001, controller 21 combines the composite video with the icon video indicating that the area is the display area for the reduced video of last ch. In addition, in the display area corresponding to the service that is stored as non-contracted in contract information 31b acquired from portal server 30 in step S101, controller 21 combines the composite video with the icon video indicating that the service is non-contracted, as the video different from the corresponding video. Thus, in first browser video 100, controller 21 can control whether to display the desired reduced video or to display the video different from the reduced video (for example, the icon video).

In summary, in the video of second browser video 200 illustrated in FIG. 10C, display area R001 displays the icon video indicating that the area is the display area of last ch. First display areas R101 to R107 display the icon videos of Dch1 to Dch5, BSch1, BSch2, respectively. Second display areas R202 to R213, R215 display the reduced videos of CSch2 to CSch13, CSch15, respectively. Second display areas R201 and R214 display the icon videos indicating that the services are non-contracted.

Note that although illustration is omitted, area R4 may display moving picture content V2 of the second aspect.

When last ch is the second service (“second service” in S115), controller 21 generates second browser video 200 that displays the reduced video of last ch and the plurality of reduced videos of the second service (S117). Second browser video 200 does not display the reduced videos of the first service. That is, in each of the plurality of first display areas, second browser video 200 displays the video different from the first reduced video corresponding to each of the first display areas.

FIG. 10D is a diagram illustrating another example of the video of second browser video 200 according to the present exemplary embodiment. Second browser video 200 displays the plurality of second reduced videos and does not display the plurality of first reduced videos. In FIG. 10D, unlike in FIG. 10C, the reduced video of last ch is also displayed.

In FIG. 10D, the second service at which cursor C points is CSch7. The service the viewer has lastly viewed is the second service. In FIG. 10D, since both of the service at which cursor C points and last ch are the second service, second browser video 200 displays second reduced video group 120 including second reduced video 122 and second reduced video 123, and reduced video 101 of last ch.

In a similar manner to FIG. 10A, controller 21 combines template video 31c with the reduced video group to generate the composite video. When arrangement of respective reduced videos in the reduced video group acquired from the broadcast wave does not agree with arrangement of the reduced video group in specification information 25d, controller 21 rearranges the reduced videos in accordance with specification information 25d. In this case, after rearranging the plurality of reduced videos included in the reduced video group, controller 21 combines template video 31c with the reduced video group after rearrangement to generate the composite video.

Controller 21 combines the composite video with the icon videos of Dch1 to Dch5, BSch1, BSch2 in first display areas R101 to R107 of area R1, respectively, as videos different from the corresponding videos. In addition, in the display area corresponding to the service that is stored as non-contracted in contract information 31b acquired from portal server 30 in step S101, controller 21 combines the composite video with the icon video indicating that the service is non-contracted, as the video different from the corresponding video. Thus, in the first browser video, controller 21 can control whether to display the desired reduced video or to display the video different from the reduced video (for example, the icon video).

In summary, in the video of second browser video 200 illustrated in FIG. 10D, display area R001 displays the video of last ch. First display areas R101 to R107 display the icon videos corresponding to Dch1 to Dch5, BSch1, BSch2, respectively. Second display areas R202 to R213, R215 display the videos of CSch2 to CSch13, CSch15, respectively. Second display areas R201 and R214 display the icon videos indicating that the services are non-contracted.

Note that although illustration is omitted, area R4 may display moving picture content V2 of the second aspect.

After executing one of steps S113 to S117, controller 21 combines the video of cursor C with the generated video (S118). In the present exemplary embodiment, controller 21 combines cursor video 25c stored in storage unit 25 with the video generated in one of steps S113 to S117. Cursor video 25c is combined at a position indicated by cursor positional information 25b.

Accordingly, the browser video is generated. Note that STB 20 may be configured to acquire cursor video 25c from portal server 30. In addition, storage unit 25 may store information for generating cursor video 25c instead of storing cursor video 25c itself. In this case, controller 21 generates cursor video 25c, and then combines generated cursor video 25c with the video generated in one of steps S113 to S117.

Controller 21 outputs the generated browser video to TV 60.

Controller 21 acquires the audio of the service at which cursor C points from the multiplexed audio and then outputs the audio to TV 60. Note that the service at which cursor C points has already been identified in execution of step S104.

### [2-3-3. Remote Controller Operation]

A remote controller operation will be described with reference to FIG. 6B. In step S104, controller 21 generates the browser video and displays the browser video on TV 60. Furthermore, controller 21 outputs the audio of the service at which cursor C points or the audio corresponding to moving picture content V2 from the speaker of TV 60. In S105, if the direction key of remote controller 50 is depressed (“move cursor” in S105), processing moves to step S104. STB 20 moves cursor C in response to the depressed direction key and then identifies the service at which cursor C after movement points.

If the service at which cursor C points switches between the first service and the second service, STB 20 switches the video to be output to TV 60 between first browser video 100 and second browser video 200 in accordance with cursor C after movement. When the service at which cursor C points switches within the first services, STB 20 switches the reduced video to be eventually displayed in first browser video 100. STB 20 switches the audio to be output to TV 60 from the audio of the service at which cursor C before movement points to the audio of the service at which cursor C after movement points. The audio may be the audio corresponding to moving picture content V2 of the second aspect as it is.

In a state where the browser video is displayed (S104), if the decision key of remote controller 50 is depressed (“decision key” in S105), STB 20 finishes the channel selection mode.

In a case where the position of cursor C when the decision key is depressed is in the display area included in one of areas R0 to R2 or in third display area R301, STB 20 moves to the normal mode and outputs to TV 60 the video and audio of the service at which cursor C points.

In a case where the position of cursor C when the decision key is depressed is in one of third display areas R302 to 308 included in area R3, STB 20 moves to the app mode and acquires menu app 31f associated with the display area from portal server 30. STB 20 activates acquired menu app 31f and displays the screen of menu app 31f (recording list, reservation list, or the like).

In a case where the position of cursor C when the decision key is depressed is in area R4, STB 20 displays the moving picture content of the first aspect or another aspect.

### [2-4. Recording Mode]

STB 20 moves to the recording mode at a recording start time of one or more services of which recording has been reserved using EPG or the like, and at a time of depression of the recording key of remote controller 50. When broadcast wave receiver 23 includes two or more tuners, STB 20 can execute operations related to the recording mode in parallel with execution of operations related to the normal mode or the channel selection mode.

Here, recording of the browser video will be described. STB 20 according to the present exemplary embodiment can record the browser video that is output by the content browser. STB 20 can record the browser video in storage unit 25 in a similar manner to the normal first service and the second service. Storage unit 25 may record the browser video in the internal hard disk drive, and if STB 20 has a recording function into another medium, storage unit 25 may use this recording function. Examples of another medium include a digital versatile disc (DVD), a Blu-ray (registered trademark) (BD) disc, and an externally connected hard disk drive.

STB 20 records the browser video when recording of the browser video is reserved, or when the recording key of remote controller 50 is depressed while the browser video and audio are output to TV 60.

In recording of the content browser, STB 20 stores record data including template video 31c, reduced video group, multiplexed audio, mapping information 31a, contract information 31b, permission information 31d, icon video group 31e, and specification information 25d. When playing the recorded browser video, STB 20 generates the moving picture content along with the browser video by using these pieces of record data, and STB 20 acquires the audio from the multiplexed audio included in the record data or the moving picture content. STB 20 outputs the generated browser video, the moving picture content, and the audio to TV 60.

In addition, when one of the first service and the second service is selected in playback of the recorded browser video, controller 21 enlarges the reduced video of the selected service to display the video on the entire screen. Regarding the audio, because the audio of the service included in the multiplexed audio has been extracted and output since cursor C moves, the audio of the service is output continuously.

Note that STB 20 may be configured, depending on an intention of the advertiser or right holder (the broadcaster that provides the service), to newly acquire contract information 31b or permission information 31d at a time of playback.

In a case where the browser video is played using contract information 31b at a time of playback, even if the service is non-contracted at a time of recording, if the service is contracted at a time of playback, the viewer may view the reduced video of the service or enlarged video of the reduced video.

Similarly, in a case where the browser video is played using permission information 31d at a time of playback, recording may be performed including non-contracted services at a time of recording because permission information 31d is checked at a time of playback. Accordingly, if the service has permission for simultaneous display of the reduced video with other reduced videos on one screen at a time of playback even if the service has no such permission at a time of recording, the reduced video of the service may be simultaneously displayed with other reduced videos on one screen. That is, in a case where the service has the permission at a time of playback, the service which is the first service at a time of recording may be regarded as the second service.

In addition, STB 20 may be configured, in a case where one of contract information 31b at a time of recording and contract information 31b at a time of playback includes information that the service is contracted, to allow viewing of the reduced video of the service.

In addition, in a case where the browser video is played using permission information 31d at a time of playback, recording may be performed including the service that has no permission for simultaneous display of the reduced video with other videos at a time of recording, because permission information 31d is checked at a time of playback. STB 20 may be configured, if a service classified as the first service that has no permission for simultaneous display of the reduced video with other reduced videos at a time of recording has the permission at a time of playback, to display the reduced video of the service simultaneously with other reduced videos.

Conversely, STB 20 may be configured, if a service classified as the second service at a time of recording becomes a service classified as the first service at a time of playback, to avoid displaying the reduced video of this service simultaneously with other reduced videos.

### [3. Advantageous Effects, Etc.]

STB 20 according to the present exemplary embodiment displays the moving picture content of the first aspect when the channel selection service is selected. This makes it possible to effectively use a time period until the content browser is activated to display desired moving picture content, for example, an advertising moving picture to the viewer.

In addition, this makes it possible to make an impression different from an impression of the normal mode on the viewer by avoiding displaying the moving picture content on the entire screen of TV 60 and to cause the viewer to recognize that the content browser is activated. Furthermore, this makes it possible to impress the viewer with STB 20 moving from the normal mode and the content browser being activated, by displaying the progress bar and the like together with the moving picture content. Thus, this may also impress the viewer that special moving picture content that is not a series of moving pictures of the service is displayed when the viewer operates the remote controller and depresses the channel selection key.

Regarding the first service that has no permission for simultaneous display of the reduced video with the reduced videos of other services on one screen, STB 20 according to the present exemplary embodiment provides the first browser video that avoids displaying the reduced videos of other services while the reduced video of the first service is displayed. Regarding the second service that has the above-described permission, STB 20 according to the present exemplary embodiment provides the second browser video that displays one or more second reduced videos of the second service simultaneously on one screen. This makes it possible to provide the appropriate browser video according to presence of the above-described permission.

The second browser video, which displays the plurality of videos (moving pictures) of the second service simultaneously, enables the viewer who is viewing TV 60 to visually recognize a plurality of programs. This enables the viewer to perform smooth service selection, and enables improvement in convenience and reduction in power consumption by a decrease in operational frequency.

In general, one service requires one tuner for generating the reduced video on an STB 20 side. According to the present exemplary embodiment, the reduced video group (reduced image group) is generated on a broadcasting station 10 side, and then the reduced image group is superimposed on the broadcast wave as one service. On an STB 20 side, the plurality of reduced videos corresponding to the plurality of services is obtained only by reception of the service that transmits the reduced image group from the broadcast wave. On the STB 20 side, this makes it possible to simultaneously display the reduced videos of the plurality of services, without having a number of tuners identical to a total number of the plurality of services.

In addition, according to the present exemplary embodiment, broadcasting station 10 generates the reduced video group. This eliminates the need for receiving the plurality of services simultaneously and reducing the videos of respective services on the STB 20 side. Drawing processing of the icon video and cursor C is performed on the STB 20 side, and a load caused by such processing is small as compared with reduction of the video. This allows control of an amount of information processing on the STB 20 side, and reduction in costs of STB 20 may be expected. In addition, since the amount of information processing on the STB 20 side is controlled, high-speed operation of the content browser may be expected.

Furthermore, the video receiving apparatus and the video display method according to the present disclosure can control the reduced videos displayed after activation of content based on presence of the contract and permission for each service. This enables continuous playback of the moving picture content from during activation until after activation of the content browser, even if the services that may be viewed include the service that may not be displayed simultaneously with the moving picture content. This enables a display of the moving picture content longer than a time period needed for activation of the content browser without awkwardness.

Furthermore, the video receiving apparatus and the video display method according to the present disclosure enables continuous playback of the audio related to the moving picture content from during activation until after activation of the content browser. This enables reduction in awkwardness the viewer feels at a moment when the moving picture content switches from the first aspect to the second aspect.

In addition, the video receiving apparatus and the video display method according to the present disclosure can control the video and audio of the moving picture content independently. This also enables playback of only the audio related to the moving picture content even if the video of the moving picture content is not displayed after activation of the content browser. Continuous playback of the audio related to the moving picture content may reduce awkwardness the viewer feels even if the video of the moving picture content is partially played.

### [Variation 1]

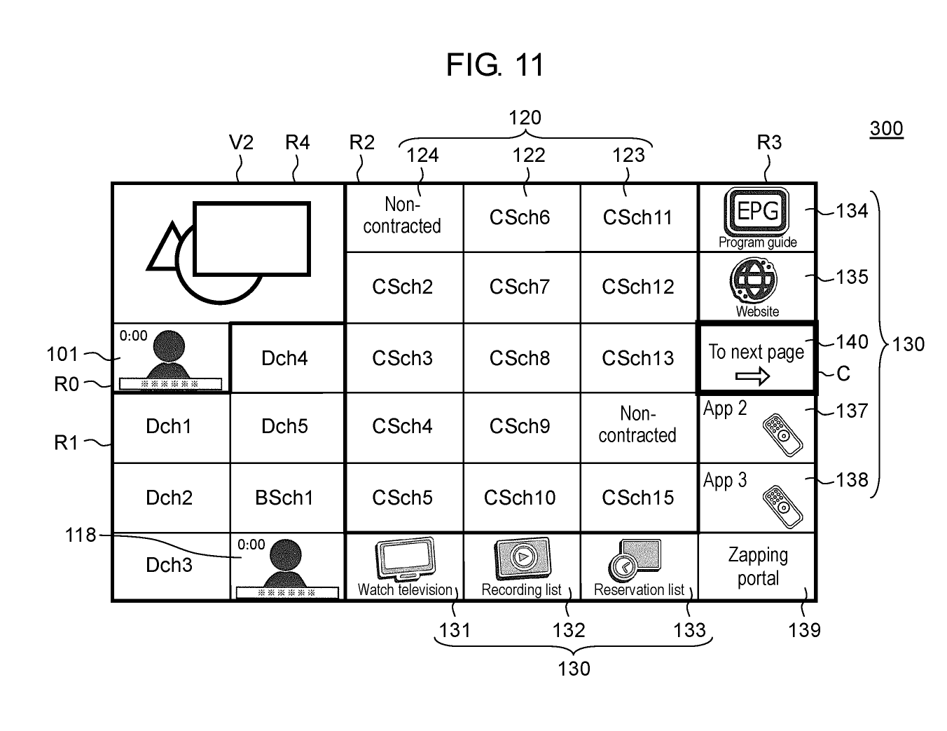

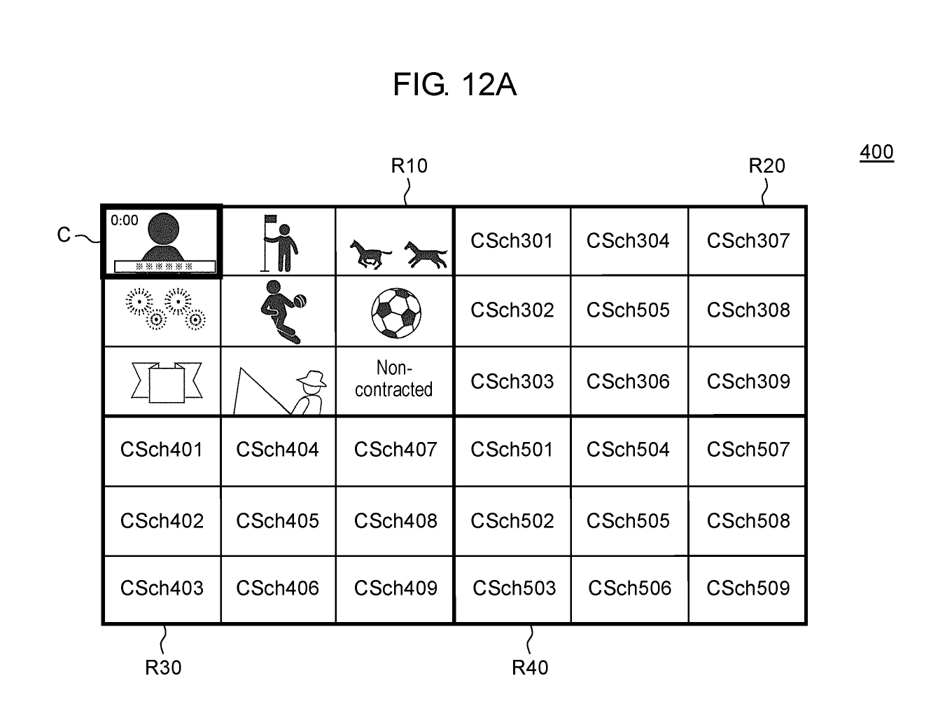

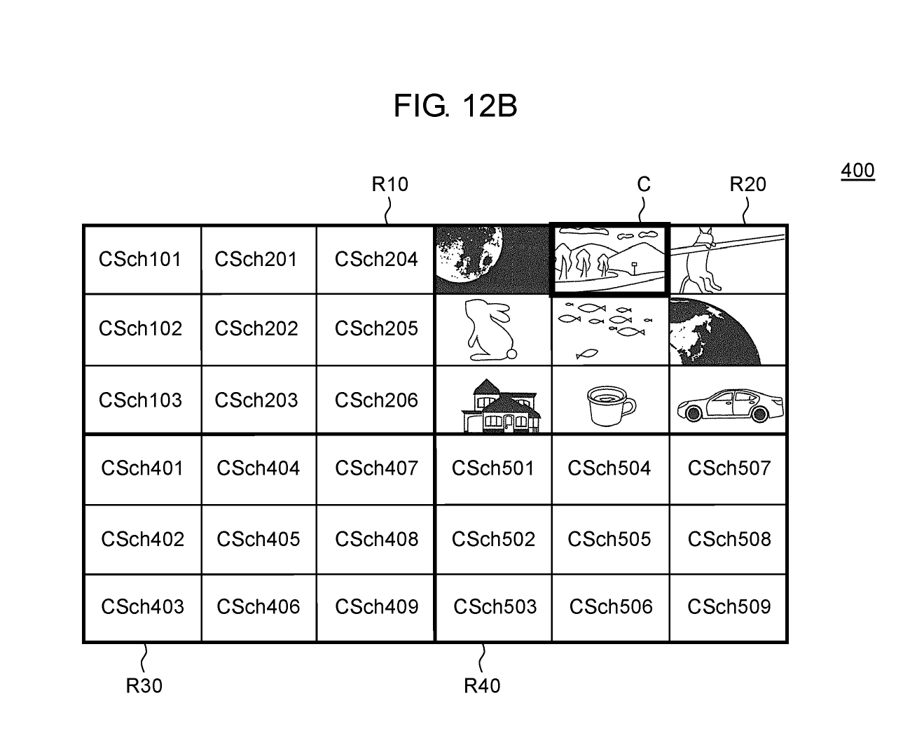

The video receiving apparatus and the video display method according to variation 1 will be described with reference to FIG. 11, FIG. 12A, and FIG. 12B.

The present variation describes a case where, for example, in the channel selection mode, the plurality of reduced videos of the service is displayed over a plurality of pages. Note that the present variation is particularly useful in a case where there are too many reduced videos of the second service for the browser video on page 1 to display.

FIG. 11 is a diagram illustrating an example of the browser video on page 1 according to the present variation. FIG. 12A and FIG. 12B are diagrams each illustrating an example of the browser video on and after page 2 according to the present variation.

The browser video of FIG. 11 differs from the browser videos of FIG. 10A to FIG. 10D in that icon video 140 for displaying a next page is disposed in a section that displays icon video 136 of app 1 in FIG. 10A to FIG. 10D. Depressing the decision key of remote controller 50 while cursor C points at the position of icon video 140 as illustrated in FIG. 11 brings about a shift to page 2 or after illustrated in FIG. 12A or FIG. 12B.

Although this example describes a case where icon video 140 for displaying the next page is displayed in the section of icon video 136 of app 1, a method for shifting to the next page is not limited to this example. While one of the browser videos of FIG. 10A to FIG. 10D is displayed and cursor C is positioned in a rightmost display area, another page may be displayed in response to further depression of the direction key of remote controller 50 indicating a rightward direction. Similarly, another page may be displayed in response to depression of the direction key of remote controller 50 indicating a leftward, upward, or downward direction while cursor C is positioned in a leftmost, uppermost, or lowermost display area. In addition, STB 20 may be configured to display an icon (for example, an arrow) indicating that there exists a next page, when cursor C is positioned in the display area of an upper, lower, right, or left end.

In FIG. 12A and FIG. 12B, two by two areas, that is, four areas R10, R20, R30, and R40 are arranged, and in each of these four areas, three by three display areas are arranged. That is, six by six display areas are arranged in FIG. 12A and FIG. 12B.

One or more categories are assigned to each area. For example, the category of area R10 is news and sports. Area R10 displays the reduced videos of services of companies that mainly broadcast news programs or sports programs. The category of area R20 is movies, for example. Area R20 displays the reduced videos of services of companies that mainly broadcast movies. Similarly, themes are also determined for areas R30 and R40.

Although the present variation assigns one or more categories to each area, arbitrary reduced videos may be arranged in each area, for example, for each viewer, and in decreasing order of frequency of viewing the services. Although areas R10, R20, R30, and R40 are identical in size in the present variation, the sizes are not limited to this example.

In the browser video on and after page 2 configured in this way, controller 21 displays the reduced videos in the display areas that belong to the area in which cursor C is positioned. Controller 21 displays the icon videos that indicate the corresponding services in the display areas that belong to the area in which cursor C is not positioned. Note that the videos illustrated in FIG. 12A and FIG. 12B may be defined as the video on page 1.

In addition, one of the areas of each page may be defined as the area for displaying the moving picture content.

The present variation may also produce an effect similar to the effect of the exemplary embodiment.

### [Variation 2]

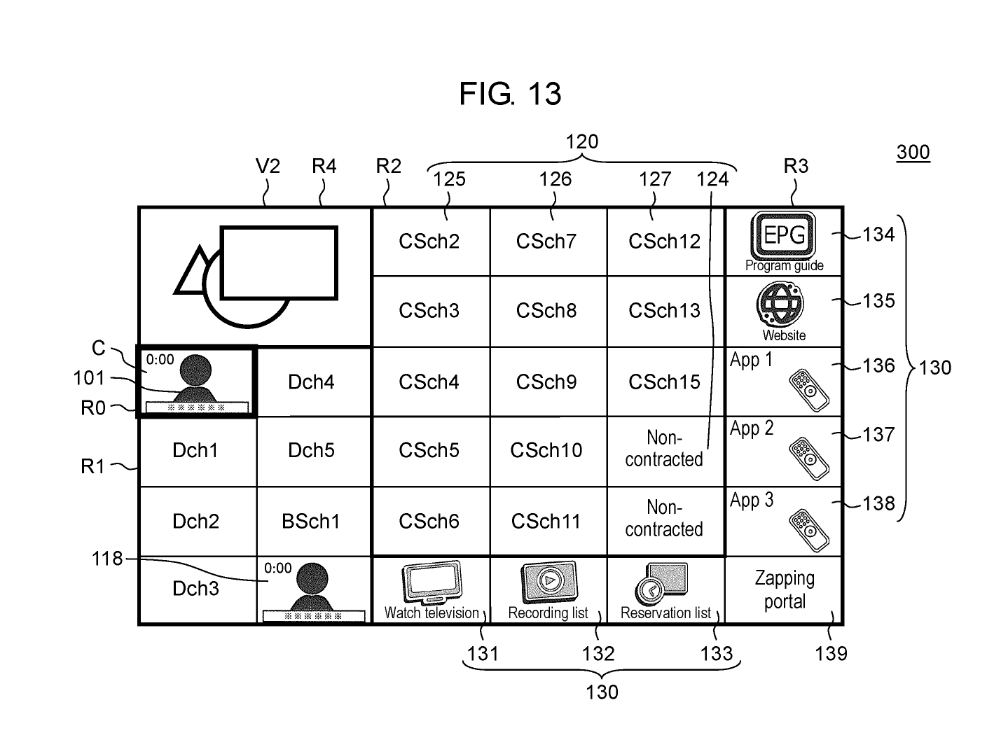

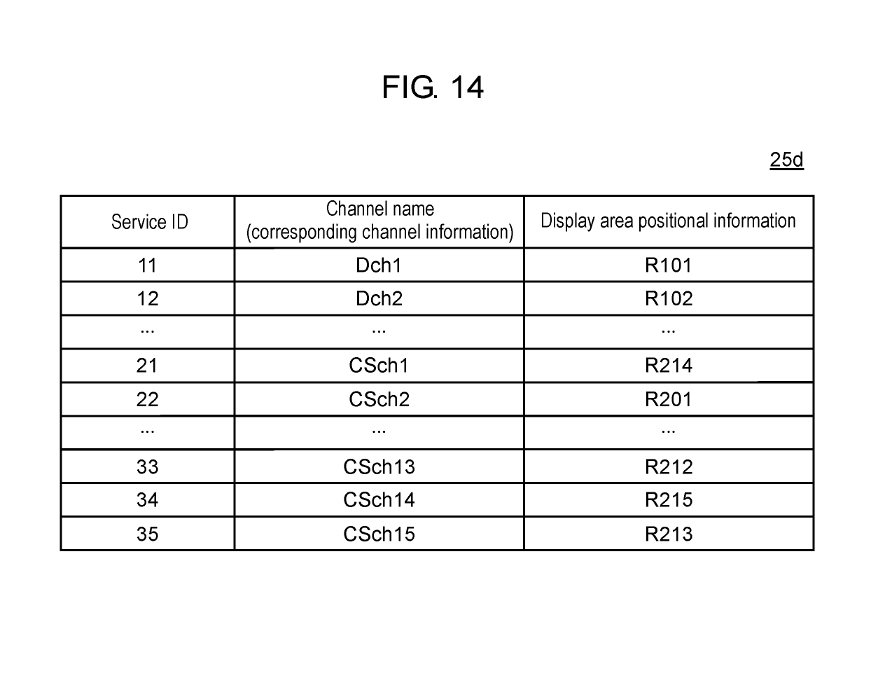

The video receiving apparatus and the video display method according to variation 2 will be described with reference to FIG. 13 and FIG. 14. The present variation describes a case where the positions of the display areas that display the reduced videos of the first service and the second service may be customized by the viewer.

In this variation, the operational modes include a registration mode.

In the registration mode, STB 20 changes the current specification of the screen in the channel selection mode in response to viewer operations.

Storage unit 25 of STB 20 stores the specification of the screen in the current channel selection mode, that is, storage unit 25 of STB 20 stores specification information 25d that stores the position of the display area displaying the reduced video for each of the plurality of services. As initial values of specification information 25d, information illustrated in FIG. 2B is stored.

FIG. 13 is a diagram illustrating an example of the video of first browser video 300 after the specification change according to the present variation. FIG. 14 is a diagram illustrating an example of specification information 25d after the specification change according to the present variation.

In the examples illustrated in FIG. 13 and FIG. 14, the reduced videos are interchanged in area R2. Specifically, non-contracted services are collected together in the lower right of area R2. In FIG. 13 and FIG. 14, CSch2 to CSch13, CSch15 are associated with second display areas R201 to R213, respectively, whereas CSch1 and CSch14 are associated with second display areas R214 and R215, respectively.

Thus, it is also possible to collect, for example, the services with little opportunity to view. To put it another way, it is possible to rearrange the display positions of the reduced videos according to the opportunity to view. This may further facilitate channel selection by the viewer. This may also produce an effect similar to the effect of the exemplary embodiment.

In addition, moving picture content V2 of the second aspect may be displayed also in the registration mode.

### Other Exemplary Embodiments

As described above, the exemplary embodiment has been described as illustration of the technique to be disclosed in this application. However, the technique in the present disclosure is not limited to this example, and may be applied to exemplary embodiments to which changes, replacements, additions, and omissions have been made as necessary. Thus, other exemplary embodiments will be described below.

(1) Although the above-described exemplary embodiment, variation 1, and variation 2 have described the videos illustrated in FIG. 10A to FIG. 10D as examples of the browser video, the browser video is not limited to these examples. In addition to the videos illustrated in FIG. 10A to FIG. 10D, the browser video may further display additional information.

For example, each of first display areas R101 to R107 and second display areas R201 to R215 may display the channel number.

(2) In the above-described exemplary embodiment, variation 1, and variation 2, although the non-contracted contract-required service has a display of the icon video indicating that the service is non-contracted, the method for displaying the contract-required service is not limited to this example.

STB 20 may be configured, depending on an intention of the broadcaster that provides the contract-required service, for example, to display the reduced video of the contract-required service as it is together with information indicating that the service is “non-contracted”, instead of substituting the video of the contract-required service completely. The information that indicates “non-contracted” is displayed, for example, on the video of the contract-required service, or near the contract-required service (such as on the frame).

Controller 21 may display the reduced video of the contract-required service when contract information 31b stores information indicating that the “non-contracted” contract-required service may be viewed temporarily, or when broadcasting station 10 specifies a period of time in which the “non-contracted” contract-required service may be viewed temporarily. In this case, controller 21 may further add information indicating that the service may be viewed temporarily to the video of the contract-required service or near the contract-required service (such as on the frame). Such a configuration makes it possible to urge the viewer to make a contract for the contract-required service (to advertise the contract-required service).

(3) In the above-described exemplary embodiment, variation 1, and variation 2, although controller 21 stores data for displaying the content browser when recording the content browser in the recording mode, the configuration of controller 21 is not limited to this example. Controller 21 may store the video for the first browser video and the video for the second browser video generated in step S104 of FIG. 6B (FIG. 9).

(4) In the above-described exemplary embodiment, variation 1, and variation 2, regarding the audio, although STB 20 is configured so that broadcasting station 10 generates the multiplexed audio and includes the generated multiplexed audio in the broadcast wave that is output to STB 20, the configuration of broadcasting station 10 and STB 20 is not limited to this example.

For example, when broadcast wave receiver 23 of STB 20 includes two or more tuners, STB 20 may be configured so that one tuner may decode the reduced image group while another tuner may decode the normal audio of the service selected by cursor C of the content browser instead of the multiplexed audio.

In this case, broadcasting station 10 does not need to generate and output the multiplexed audio. Broadcasting station 10 may however be configured to generate the multiplexed audio for recording of the content browser.

(5) In the above-described exemplary embodiment, variation 1, and variation 2, although STB 20 is configured to acquire contract information 31b from portal server 30, the configuration of STB 20 is not limited to this example. For example, STB 20 may be configured to tune the plurality of services included in the broadcast wave in turn to determine whether the services are non-contracted. Alternatively, STB 20 may refer to information stored in a terminal or a CAS card.

(6) In the above-described exemplary embodiment, variation 1, and variation 2, although STB 20 is configured so that communicator 24 may acquire mapping information 31a and the like from portal server 30 when STB 20 moves to the channel selection mode, the configuration of STB 20 is not limited to this example. Mapping information 31a may be acquired at other timing, such as when STB 20 is turned on. Alternatively, STB 20 may be configured to download mapping information 31a and the like within STB 20 in advance, to receive update notification from a broadcasting station 10 or portal server 30 side when mapping information 31a and the like are updated, and to receive mapping information 31a and the like from broadcast wave receiver 23 or communicator 24.

(7) In the above-described exemplary embodiment, variation 1, and variation 2, although mapping information 31a and the like are acquired from portal server 30, the configuration of STB 20 is not limited to this example. STB 20 may be configured so that broadcasting station 10 generates the broadcast wave including these pieces of information, and STB 20 extracts these pieces of information from the broadcast wave.

(8) Although the above-described exemplary embodiment, variation 1, and variation 2 have described the example in which STB 20 receives the broadcast wave of cable broadcasting from broadcasting station 10, the configuration of STB 20 is not limited to this example. STB 20 may be configured, for example, to receive IP content and the like on the Internet as part or all of the service. Alternatively, although the above-described exemplary embodiment, variation 1, and variation 2 have described the example in which the video receiving apparatus is STB 20, the video receiving apparatus is not limited to this example. The video receiving apparatuses may be another apparatus that receives IP content on the Internet, for example.

(9) Although the above-described exemplary embodiment, variation 1, and variation 2 have described that controller 21 is a CPU or arithmetic processor, controller 21 may have any physical configuration as long as controller 21 controls the video receiving apparatus. Note that when controller 21 is configured to use a CPU (or a microcontroller) and to control the video receiving apparatus by execution of a control program, changing the control program allows the processing procedure to be changed, leading to greater flexibility of design of controller 21. In addition, controller 21 may be implemented by hard logic. Implementing controller 21 by hard logic is effective in improving processing speed. Controller 21 may include one device, and may physically include a plurality of devices. When controller 21 includes the plurality of devices, respective types of control described in the claims may be implemented by separate devices. In this case, the plurality of devices may be considered to constitute one controller 21. In addition, one device may constitute controller 21 and a member that has a function different from the function of controller 21.

(10) Although the above-described exemplary embodiment, variation 1, and variation 2 have described a case where infrared communication is used as communication between STB 20 and remote controller 50, communication between STB 20 and remote controller 50 is not limited to this example.

(11) In the above-described exemplary embodiment, variation 1, and variation 2, although broadcasting station 10 generates the reduced video group, STB 20 or portal server 30 may generate the reduced video group.

Since the first browser video may be generated by insertion of one first reduced video into the template video, one tuner can generate the first browser video from the broadcast wave. Accordingly, the browser videos may be generated in a distributed manner, for example, STB 20 generates the first browser video while broadcasting station 10 generates the second browser video.

(12) In the above-described exemplary embodiment, variation 1, and variation 2, although the display area that corresponds to no service displays a blank or the icon video indicating that the display area corresponds to no service, the configuration of STB 20 is not limited to this example. Such a so-called blank area may display other arbitrary information. Examples of other arbitrary information may include information on the service selected by cursor C, information on merchandise related to the service selected by cursor C, information on other recommended services, and images of TV shopping.

(13) In the above-described exemplary embodiment, variation 1, and variation 2, although STB 20 acquires the video and audio of the service from the broadcast wave, STB 20 is not limited to this example. STB 20 may receive the video and audio of the service (for example, the video and audio of IP (Internet Protocol) broadcast) from the network via communicator 24. Alternatively, when STB 20 further includes a communicator that supports other communication paths (such as power line communications, wireless communications), STB 20 may acquire the video and audio of the service by using the communicator that supports other communication paths.

(14) Although the above-described exemplary embodiment, variation 1, and variation 2 have described an example in which cursor positional information 25b is initialized to the position of the upper left display area at the time of display start of the browser video, the configuration of STB 20 is not limited to this example. For example, STB 20 may be configured to hold the position at the time of display completion of the browser video as it is, and to allow the viewer or broadcasting station 10 to specify a specific position.

(15) Although the above-described exemplary embodiment, variation 1, and variation 2 have described a case where specification information 25d includes the service ID, channel name of each service, and display area positional information, specification information 25d is not limited to this example. Specification information 25d may not include the display area positional information of some services. In addition, specification information 25d may further include other information, such as the category of each service.

(16) Although the above-described exemplary embodiment, variation 1, and variation 2 have described tuner unit 12 of broadcasting station 10 in which each of the plurality of tuners decodes the video and audio of the corresponding service from the first broadcast wave, the configuration of STB 20 is not limited to this example. For example, STB 20 may acquire the video and audio of each of part or all of the services by using dedicated lines.

(17) Although the above-described exemplary embodiment, variation 1, and variation 2 have described a case where audio multiplexer 14 multiplexes the audio signals of the plurality of services that are output from the plurality of tuners that constitute tuner unit 12 to generate the multiplexed audio, audio multiplexing is not limited to this example. The multiplexed audio may include other audio signals included in neither the first service nor the second service, such as environmental music (hereinafter referred to as outside service audio). The outside service audio may be environmental music or the like.

In this case, when displaying the browser video, STB 20 may output the outside service audio such as environmental music, instead of the audio of the service at which cursor C points.

(18) Although the above-described exemplary embodiment, variation 1, and variation 2 have described a case where, when displaying the browser video, controller 21 acquires the audio of the service at which cursor C points from the multiplexed audio and then outputs the audio to TV 60, controller 21 is not limited to this example.

For example, controller 21 may output the outside service audio. This outside service audio may be stored in storage unit 25 in advance, or controller 21 may acquire the outside service audio from portal server 30 via network 40 and may then store the outside service audio in storage unit 25.

In addition, controller 21 may not output any audio when displaying the browser video.

In addition, controller 21 may switch the audio to be output according to whether the service at which cursor C points is the first service or the second service. Specifically, when the service at which cursor C points is the first service, controller 21 may acquire the audio of the service at which cursor C points from the multiplexed audio and then output the audio. When the service at which cursor C points is the second service, controller 21 may output the outside service audio or may not output any audio.

(19) Although the above-described exemplary embodiment, variation 1, and variation 2 have described a case where STB 20 moves to the channel selection mode when the channel selection key is depressed, the configuration of STB 20 is not limited to this example. STB 20 may be configured to move to the channel selection mode when a power source of STB 20 is changed from off to on, or at other specified timing.

(20) Although the above-described exemplary embodiment, variation 1, and variation 2 have described a case where reduced video group SDV includes the reduced videos of the plurality of first services and the plurality of second services, reduced video group SDV may not include the reduced videos of the first services.

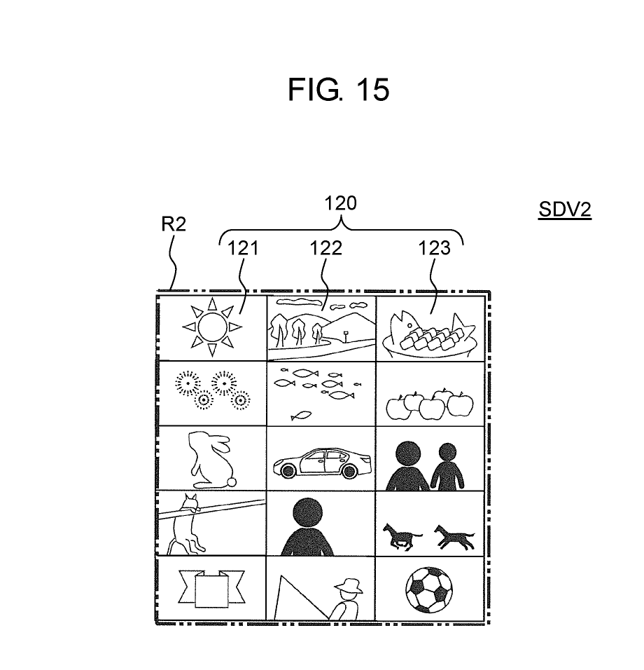

FIG. 15 is a diagram illustrating an example of reduced video group SDV2 including the reduced videos of the plurality of second services.

In this case, for example, controller 21 decodes the videos of the second services from the broadcast wave by using the tuners of broadcast wave receiver 23, and then controller 21 generates the reduced videos of the second services by performing reduction processing on the videos.

(21) Although the above-described exemplary embodiment, variation 1, and variation 2 have described a case where controller 21 generates the composite video obtained by combining template video 31c with reduced video group SDV, and then controller 21 performs mask processing for combining the icon videos with the composite video, controller 21 is not limited to this example.

Controller 21 may cut out the reduced videos to be displayed, from the reduced video group, and may then combine the cut reduced videos with template video 31c.

(22) STB 20 may transmit information that the moving picture content has been displayed to moving picture distributing server 70 via communicator 24 of STB 20 and communicator 72 of moving picture distributing server 70. In addition, the information that the moving picture content has been displayed may include an ID indicating the moving picture content, a time period during which the moving picture content is displayed in the first aspect, a time period during which the moving picture content is displayed in the second aspect, and a time when the moving picture content is displayed.

(23) Although the present exemplary embodiment has described a case where area R4 that displays the moving picture content is larger than the area that displays one reduced video in size, area R4 that displays the moving picture content may be identical to the area that displays one reduced video in size.

(24) The present exemplary embodiment has described a case where the viewer depresses the channel selection key provided in remote controller 50 as a trigger for starting the content browser. However, the trigger is not particularly limited. For example, turning on STB 20 by the viewer may be used as a trigger for activating the content browser.

(25) In the above-described exemplary embodiment, variation 1, and variation 2, each display area displays the icon video that indicates the corresponding service as the video different from the reduced video corresponding to the display area. However, the video different from the reduced video corresponding to the display area is not limited to this example. For example, a monochromatic video, such as a white, black, and blue video, may be displayed instead of the icon video. In addition, a video of a specific pattern may be displayed instead of the icon video. However, it is more preferable to display the icon video that indicates the corresponding service because the icon video makes it easy to understand to which service the display area corresponds.

As described above, the exemplary embodiment has been described as illustration of the technique in the present disclosure. For this purpose, the accompanying drawings and detailed description have been provided.

Accordingly, the components described in the accompanying drawings and detailed description may include not only essential components but also unessential components in order to illustrate the above-described technique. From this reason, it should not be acknowledged immediately that those unessential components be essential because those unessential components are described in the accompanying drawings and detailed description.

In addition, since the above-described exemplary embodiment is intended to illustrate the technique in the present disclosure, various changes, replacements, additions, omissions, etc. may be made within the scope of the appended claims or equivalents thereof.

For example, the video receiving apparatus may include the following video processor. The video processor outputs, to the video display apparatus, the browser video for allowing the viewer to select one service from the plurality of services including the plurality of first services and the plurality of second services. The browser video includes the plurality of first display areas, the plurality of second display areas, and the cursor that points at one of the plurality of first display areas and the plurality of second display areas. The first display areas are display areas for displaying the first reduced videos obtained by reduction of the videos of the first services. The second display areas are display areas for displaying the second reduced videos obtained by reduction of the videos of the second services. When the cursor points at one of the plurality of first display areas, the video processor displays the first reduced video corresponding to the first display area in the first display area at which the cursor points. In this case, the video processor outputs, to the video display apparatus, the first browser video that displays the video different from the first reduced video or the second reduced video in each of other first display areas except the above-described first display area and the plurality of second display areas. When the cursor points at one of the plurality of second display areas, the video processor outputs, to the video display apparatus, the second browser video that displays, in each of the plurality of second display areas, the second reduced video corresponding to the second display area, the second browser video displaying, in each of the plurality of first display areas, the video different from the first reduced video.

The above-described first service is, for example, a service that has no permission for simultaneous display of the reduced video of the first service with the reduced videos of other services on one screen. In this case, the above-described second service is a service that has the permission for simultaneous display with the reduced videos of other services on one screen.

Furthermore, the video receiving apparatus may include the service receiver that receives the reduced video group including the plurality of first reduced videos and the plurality of second reduced videos from peripheral devices.

In addition, the video processor may generate the first browser video and the second browser video as follows. The video processor acquires the template video including the plurality of first display areas and the plurality of second display areas. In the first display area at which the cursor points, the video processor combines the first reduced video corresponding to the display area with the acquired template video. In each of other first display areas except the first display area at which the cursor points and the plurality of second display areas, the video processor generates the first browser video by combining the icon video with the acquired template video. The video processor further generates the second browser video by combining the second reduced video corresponding to each of the plurality of second display areas with the acquired template video, and combining the icon video in each of the plurality of first display areas with the acquired template video.

In addition, the icon video may be the video that uses the figure, text, or both that indicates the corresponding service among the plurality of services.

In addition, the browser video may include the multiplexed audio obtained by multiplexing of the plurality of audio signals of the plurality of services. The video processor may extract the audio of the service at which the cursor points from among the plurality of services from the above-described multiplexed audio, and may then output the extracted audio to the video display apparatus.

While the first browser video or the second browser video is displayed in the video display apparatus, in response to the cursor movement request, the video processor may move the cursor and switch the audio to be output to the video display apparatus as follows. That is, the video processor identifies the service at which the cursor after movement points, and then switches the audio to be output to the video display apparatus from the audio of the service at which the cursor before movement points to the audio of the service at which the cursor after movement points.

The video processor further acquires the specification information that indicates in which display area of the plurality of display areas including the plurality of first display areas and the plurality of second display areas to display the reduced video of each of the plurality of services. The video processor may identify the service that is being displayed at the position of the cursor by using the above-described specification information while the first browser video or the second browser video is displayed.

Among the plurality of services, the video processor further acquires the contract information that indicates whether each of one or more contract-required services that require a contract for viewing has been contracted or non-contracted. For the first browser video and the second browser video, in the first display area or the second display area corresponding to the contract-required service that is indicated as non-contracted by the contract information, the video processor may display a video indicating that the service is non-contracted.

When recording the browser video, the video processor may further record the first browser video and the second browser video into which the video indicating as non-contracted is combined.

In addition, the following video display method may be provided for outputting, to the video display apparatus, the content browser for allowing the viewer to select one service from the plurality of services including the plurality of first services and the plurality of second services. The video processor displays the browser video of the content browser on the video display apparatus. The browser video includes the plurality of first display areas, the plurality of second display areas, and the cursor. The first display areas are display areas for displaying the first reduced videos obtained by reduction of the videos of the corresponding first services. The second display areas are display areas for displaying the second reduced videos obtained by reduction of the videos of the corresponding second services. The cursor points at one of the plurality of first display areas and the plurality of second display areas. When the cursor points at one of the plurality of first display areas, the video processor displays the first reduced video corresponding to the first display area at which the cursor points. The video display method may include the steps of outputting the first browser video to the video display apparatus, and outputting the second browser video to the video display apparatus. The video processor executes the step of outputting, to the video display apparatus, the first browser video that displays the icon video indicating the corresponding service in each of other first display areas except the first display area and the plurality of second display areas. When the cursor points at one of the plurality of second display areas, the video processor executes the step of outputting, to the video display apparatus, the second browser video that displays the corresponding second reduced video in each of the plurality of second display areas, the second browser video displaying the icon video indicating the corresponding first service in each of the plurality of first display areas.

The present disclosure is applicable as the video receiving apparatus and the video display method for displaying the content browser for allowing the viewer to select one service from the plurality of services. Specifically, the present disclosure is applicable to the video receiving apparatus that receives the video content from the broadcasting station that distributes the plurality of services, including the STB of cable broadcasting, such as cable TV (CATV), or an apparatus for receiving IP content.
FIG. 1
1 PERMISSION INFORMATION ICON VIDEO GROUP
2 TEMPLATE VIDEO MAPPING INFORMATION CONTRACT INFORMATION
3 FIRST CHANNEL SELECTION SERVICE SECOND CHANNEL SELECTION SERVICE
4 BROADCAST WAVE (INCLUDING REDUCED VIDEO GROUP)
10 BROADCASTING STATION
FIG. 2A
1 STORAGE UNIT
10 BROADCASTING STATION
21 CONTROLLER
22 OPERATIONAL INFORMATION RECEIVER
23 BROADCAST WAVE RECEIVER
24 COMMUNICATOR
25a RECEIVER ID
25b CURSOR POSITIONAL INFORMATION
25c CURSOR VIDEO
25d SPECIFICATION INFORMATION
26 VIDEO IMAGE/AUDIO OUTPUT UNIT
27 MOVING PICTURE ADJUSTMENT UNIT
50 REMOTE CONTROLLER
FIG. 2B
1 SERVICE ID
2 CHANNEL NAME (CORRESPONDING CHANNEL INFORMATION)
3 DISPLAY AREA POSITIONAL INFORMATION (=CURSOR POSITIONAL INFORMATION)
FIG. 3
1 BROADCASTING STATION
2 FIRST BROADCAST WAVE
3 TUNER UNIT
4 TUNER
5 BROADCAST WAVE
11 BROADCASTING FACILITY
13 REDUCED VIDEO GROUP GENERATOR
14 AUDIO MULTIPLEXER
15 MIXER
FIG. 4A
1 PORTAL SERVER
31 STORAGE UNIT
31a MAPPING INFORMATION
31b CONTRACT INFORMATION
31c TEMPLATE VIDEO
31d PERMISSION INFORMATION
31e ICON VIDEO GROUP
31f MENU APP
32 COMMUNICATOR
FIG. 4B
1 SERVICE ID
2 CHANNEL NAME
3 REDUCED VIDEO GROUP POSITIONAL INFORMATION
4 NETWORK ID
5 CHANNEL SELECTION INFORMATION
6 AUDIO INFORMATION
FIG. 4C
1 MOVING PICTURE DISTRIBUTING SERVER
2 STORAGE UNIT
71a MOVING PICTURE INFORMATION
71b VIEWING FREQUENCY
72 COMMUNICATOR
73 TOTALIZER
FIG. 5C
R0 LAST ch
R3 PROGRAM GUIDE
1 WATCH TELEVISION
2 RECORDING LIST
3 RESERVATION LIST
4 WEBSITE
5 APP 1
6 ZAPPING PORTAL
FIG. 5D
R0 LAST ch
R3 PROGRAM GUIDE
1 WATCH TELEVISION
2 RECORDING LIST
3 RESERVATION LIST
4 WEBSITE
5 APP 1
6 ZAPPING PORTAL
FIG. 5E
R0 LAST ch
R3 PROGRAM GUIDE
R4 MESSAGE MOVING PICTURE DISPLAY AREA
1 WATCH TELEVISION
2 RECORDING LIST
3 RESERVATION LIST
4 WEBSITE
5 APP 1
6 ZAPPING PORTAL
FIG. 6A
1 START (SELECT CHANNEL SELECTION SERVICE)
S201 ACQUIRE MOVING PICTURE CONTENT AND AUDIO
S202 START ACTIVATION OF CONTENT BROWSER
S203 OUTPUT MOVING PICTURE CONTENT AND AUDIO OF FIRST ASPECT
S204 IS CONDITION SATISFIED?
S205 OUTPUT MOVING PICTURE CONTENT IN SECOND ASPECT OUTPUT AUDIO AND BROWSER VIDEO TOGETHER
FIG. 6B
S101 ACQUIRE TEMPLATE VIDEO, ETC
S102 ACQUIRE REDUCED VIDEO GROUP AND MULTIPLEXED AUDIO
S103 ACQUIRE VIDEO AND AUDIO OF LAST ch
S104 GENERATE BROWSER VIDEO/DISPLAY MOVING PICTURE CONTENT TOGETHER
S105 IS REMOTE CONTROLLER OPERATED?
5106 OUTPUT VIDEO AND AUDIO OF SELECTED SERVICE/OUTPUT VIDEO OF SELECTED MENU
1 START (DEPRESS CHANNEL SELECTION KEY)
2 MOVE CURSOR
3 NO
4 DECISION KEY
FIG. 6C
1 START (STANDBY MODE)
2 MOVE CURSOR
3 DECISION
4 NO
5 UNFINISHED
6 FINISHED
S301 DISPLAY CURSOR AT POSITION POINTING AT MOVING PICTURE CONTENT
S302 ACQUIRE SECOND CONDITION
S303 IS REMOTE CONTROLLER OPERATED?
S304 MOVE CURSOR ACCORDING TO OPERATION
S305 ENLARGED DISPLAY
S306 IS DISPLAY FINISHED?
S307 MOVE CURSOR ACCORDING TO SECOND CONDITION
S308 DISPLAY ICON
FIG. 7
R301 WATCH TELEVISION
R302 RECORDING LIST
R303 RESERVATION LIST
R304 PROGRAM GUIDE
R305 WEBSITE
R306 APP 1
R309 ZAPPING PORTAL
FIG. 9
1 FIRST SERVICE
2 SECOND SERVICE
S111 SERVICE AT WHICH CURSOR POINTS?
S112 SERVICE AT WHICH CURSOR POINTS=LAST ch?
S113 (A) GENERATE VIDEO INCLUDING VIDEO OF LAST ch AND REDUCED VIDEO AT CURSOR POSITION
S114 (B) GENERATE VIDEO INCLUDING REDUCED VIDEO AT CURSOR POSITION
S115 FIRST SERVICE=LAST ch?
S116 (C) GENERATE VIDEO INCLUDING REDUCED VIDEOS OF SECOND SERVICE
S117 (D) GENERATE VIDEO INCLUDING VIDEO OF LAST ch AND REDUCED VIDEOS OF SECOND SERVICE
S118 COMBINE CURSOR VIDEO
S119 EXTRACT AUDIO ACCORDING TO CURSOR POSITION FROM MULTIPLEXED AUDIO AND OUTPUT AUDIO
FIG. 10A
124 NON-CONTRACTED
131 WATCH TELEVISION
132 RECORDING LIST
133 RESERVATION LIST
134 PROGRAM GUIDE
135 WEBSITE
136 APP 1
139 ZAPPING PORTAL
FIG. 10B
R0 LAST ch
124 NON-CONTRACTED
131 WATCH TELEVISION
132 RECORDING LIST
133 RESERVATION LIST
134 PROGRAM GUIDE
135 WEBSITE
136 APP 1
139 ZAPPING PORTAL
FIG. 10C
101 LAST ch
124 NON-CONTRACTED
131 WATCH TELEVISION
132 RECORDING LIST
133 RESERVATION LIST
134 PROGRAM GUIDE
135 WEBSITE
136 APP 1
139 ZAPPING PORTAL
FIG. 10D
124 NON-CONTRACTED
131 WATCH TELEVISION
132 RECORDING LIST
133 RESERVATION LIST
134 PROGRAM GUIDE
135 WEBSITE
136 APP 1
139 ZAPPING PORTAL
FIG. 11
124 NON-CONTRACTED
131 WATCH TELEVISION
132 RECORDING LIST
133 RESERVATION LIST
134 PROGRAM GUIDE
135 WEBSITE
137 APP 2
139 ZAPPING PORTAL
140 TO NEXT PAGE
FIG. 12A
1 NON-CONTRACTED
FIG. 13
124 NON-CONTRACTED
131 WATCH TELEVISION
132 RECORDING LIST
133 RESERVATION LIST
134 PROGRAM GUIDE
135 WEBSITE
136 APP 1
139 ZAPPING PORTAL
FIG. 14
1 SERVICE ID
2 CHANNEL NAME (CORRESPONDING CHANNEL INFORMATION)
3 DISPLAY AREA POSITIONAL INFORMATION

What is claimed is:

1. A video receiving apparatus configured to activate a content browser in response to an operation of a viewer and cause a video display apparatus to display a browser video generated by the content browser assisting the viewer in selecting a desired service from a plurality of services, the video receiving apparatus comprising a video processor that displays moving picture content in a first aspect until displaying the browser video, the video processor displaying the moving picture content along with the browser video in a second aspect different from the first aspect when a predetermined condition is satisfied.

2. The video receiving apparatus according to claim 1, wherein the video processor displays the moving picture content in part of a screen of the video display apparatus in the first aspect.

3. The video receiving apparatus according to claim 1, wherein the video processor displays information regarding the content browser along with the moving picture content displayed in the first aspect.

4. The video receiving apparatus according to claim 3, wherein the video processor displays the information in a section other than the moving picture content.

5. The video receiving apparatus according to claim 1, wherein the video processor outputs an audio of the moving picture content when displaying the moving picture content in the first aspect, and the video processor outputs continuation of the audio even after a transition to the browser video.

6. The video receiving apparatus according to claim 1, wherein when displaying the moving picture content in the second aspect, the content browser avoids displaying a reduced video of a first service that fails to have permission for simultaneous display with a reduced video of another service on one screen.

7. The video receiving apparatus according to claim 1, wherein when the predetermined condition is satisfied, the video processor displays a cursor that points at the moving picture content displayed in the second aspect.

8. The video receiving apparatus according to claim 7, wherein when the moving picture content displayed in the second aspect is finished, the video processor moves the cursor that has pointed at the moving picture content in accordance with a predetermined second condition.

9. The video receiving apparatus according to claim 8, wherein the video processor moves the cursor in accordance with the second condition obtained from a portal server or a moving picture distributing server.

10. The video receiving apparatus according to claim 7, wherein when the cursor that has pointed at the moving picture content moves to another place, the video processor displays, in an area that has displayed the moving picture content, an icon indicating that the area is an area for displaying the moving picture content.

11. A video display method to be performed by a video receiving apparatus configured to activate a content browser in response to an operation of a viewer and cause a video display apparatus to display a browser video including a list of icon videos, the content browser assisting the viewer in selecting a service based on the list of the icon videos indicating the service that may be viewed at identical time,
the video display method comprising:
displaying moving picture content in a first aspect until displaying the browser video; and
displaying the moving picture content along with the browser video in a second aspect different from the first aspect when a predetermined condition is satisfied.
